(19) United States
(12) Patent Application Publication
(10) Pub. No.: US 2025/0045115 A1
(43) Pub. Date: Feb. 6, 2025

(54) QUANTUM TASK EXECUTION METHOD AND APPARATUS, DEVICE, AND STORAGE MEDIUM

(71) Applicant: Tencent Technology (Shenzhen) Company Limited, Shenzhen (CN)

(72) Inventors: Tianyu ZHANG, Shenzhen (CN); Shengyu ZHANG, Shenzhen (CN); Yicong ZHENG, Shenzhen (CN); Xiong XU, Shenzhen (CN); Chenji ZOU, Shenzhen (CN)

(21) Appl. No.: 18/771,979

(22) Filed: Jul. 12, 2024

Related U.S. Application Data
(63) Continuation of application No. PCT/CN2023/130724, filed on Nov. 9, 2023.

(30) Foreign Application Priority Data
Aug. 4, 2023 (CN) 202310977711.3

(51) Int. Cl. G06F 9/50

(52) U.S. Cl. CPC G06F 9/5038

(57) ABSTRACT

A quantum task execution method is performed by a computer device. The method includes: obtaining a logical quantum circuit configured to execute a quantum task; generating a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits included in the virtual quantum chip; generating a physical quantum circuit in the physical quantum chip for the quantum task according to the virtual quantum circuit and a bit mapping relationship between the virtual quantum chip and the physical quantum chip; and executing the physical quantum circuit through the partial structure in the physical quantum chip, to obtain an execution result of the quantum task.

### CROSS-REFERENCE TO RELATED APPLICATIONS

This application is a continuation application of PCT Patent Application No. PCT/CN2023/130724, entitled “QUANTUM TASK EXECUTION METHOD AND APPARATUS, DEVICE, AND STORAGE MEDIUM” filed on Nov. 9, 2023, which claims priority to Chinese Patent Application No. 202310977711.3, entitled “QUANTUM TASK EXECUTION METHOD AND APPARATUS, DEVICE, AND STORAGE MEDIUM” filed on Aug. 4, 2023, both of which are incorporated by reference in their entirety.

### FIELD OF THE TECHNOLOGY

Embodiments of this application relate to the field of quantum technologies, and in particular, to a quantum task execution method and apparatus, a device, and a storage medium.

### BACKGROUND OF THE DISCLOSURE

Through a cloud platform, a high-performance physical quantum chip can be provided for a user, thereby reducing a threshold for the user to use the physical quantum chip, and expanding an application scenario of the physical quantum chip.

In the related art, there is a topology relationship between physical qubits included in the physical quantum chip. To avoid an error in states of the physical qubits, the physical quantum chip can execute only one quantum task at a time, that is, the physical quantum chip cannot synchronously execute another quantum task before the physical quantum chip generates a processing result corresponding to the quantum task.

However, utilization of computing resources is low when the physical quantum chip executes the quantum task.

### SUMMARY

Embodiments of this application provide a quantum task execution method and apparatus, a device, and a storage medium, which can divide a physical quantum chip into a plurality of virtual quantum chips. The plurality of virtual quantum chips can synchronously execute different quantum tasks, thereby improving utilization efficiency of the physical quantum chip. Technical solutions are as follows:

According to an aspect of the embodiments of this application, a quantum task execution method is provided, and is performed by a computer device. The method includes:
obtaining a logical quantum circuit, the logical quantum circuit being an abstract logic circuit configured to execute a quantum task;
generating a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits included in the virtual quantum chip;
generating a physical quantum circuit in the physical quantum chip for the quantum task according to the virtual quantum circuit and a bit mapping relationship between the virtual quantum chip and the physical quantum chip, the bit mapping relationship being configured for indicating physical qubits corresponding to the virtual qubits in the physical quantum chip; and
executing the physical quantum circuit through the partial structure in the physical quantum chip, to obtain an execution result of the quantum task.

According to an aspect of the embodiments of this application, a computer device is provided, including a processor and a memory, the memory having a computer program stored therein that, when executed by the processor, causes the computer device to implement the quantum task execution method.

According to an aspect of the embodiments of this application, a non-transitory computer-readable storage medium is provided, having a computer program stored therein that, when loaded and executed by a processor of a computer device, causes the computer device to implement the quantum task execution method.

The technical solutions provided in the embodiments of this application may bring the following beneficial effects:

Compared with a method in which a physical quantum chip executes one quantum task at a time in the related art, in this application, a physical quantum chip is segmented, so that the physical quantum chip corresponds to a plurality of virtual quantum chips that do not interfere with each other. A virtual quantum chip is selected after a target quantum task is obtained, so that a partial structure corresponding to the virtual quantum chip in the physical quantum chip participates in a process of executing the quantum task according to a bit mapping relationship, to ensure that other structures other than the partial structure in the physical quantum chip do not participate in the process of executing the quantum task. In this way, physical qubits used in the process of executing the quantum task are controllable, and the other structures are also allowed to execute other quantum tasks within the same time period.

Through the method, parallel execution of a plurality of quantum tasks is realized, so that efficiency of executing the quantum tasks can be improved, a response speed of feeding back execution results of the quantum tasks can be improved, and computing resources can be reduced. In addition, through the method, one physical quantum chip serves as a plurality of quantum chips for use, so that a quantity of physical quantum chips that need to be maintained can be reduced when increasing quantum tasks are flexibly adapted to, thereby reducing maintenance costs of the physical quantum chips.

### BRIEF DESCRIPTION OF THE DRAWINGS

FIG. 1 is a schematic diagram of an implementation environment of a solution according to an exemplary embodiment of this application.

FIG. 2 is a principle diagram of a quantum task execution method according to an exemplary embodiment of this application.

FIG. 3 is a flowchart of a quantum task execution method according to an exemplary embodiment of this application.

FIG. 4 is a schematic structural diagram of physical qubits according to an exemplary embodiment of this application.

FIG. 5 is a schematic structural diagram of a virtual quantum chip according to an exemplary embodiment of this application.

FIG. 6 is a schematic diagram of a logical quantum circuit according to an exemplary embodiment of this application.

FIG. 7 is a schematic diagram of a virtual quantum circuit according to an exemplary embodiment of this application.

FIG. 8 is a schematic diagram of a correspondence between a virtual quantum chip and a physical quantum chip according to an exemplary embodiment of this application.

FIG. 9 is a schematic diagram of a physical quantum chip according to an exemplary embodiment of this application.

FIG. 10 is a schematic diagram of a process of mapping a virtual quantum chip according to an exemplary embodiment of this application.

FIG. 11 is a schematic diagram of a process of mapping a virtual quantum chip according to another exemplary embodiment of this application.

FIG. 12 is a block diagram of a quantum task execution apparatus according to an exemplary embodiment of this application.

FIG. 13 is a structural block diagram of a computer device according to an exemplary embodiment of this application.

### DESCRIPTION OF EMBODIMENTS

To make the objectives, technical solutions, and advantages of this application clearer, implementations of this application are further described below in detail with reference to the accompanying drawings.

Before the technical solutions of this application are described, some terms involved in embodiments of this application are first explained.

A cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. The cloud technology relates to basic technologies such as cloud computing, cloud storage, databases, and big data. Cloud applications provided based on the cloud technology include a medical cloud, a cloud Internet of Things, cloud security, cloud calling, a private cloud, a public cloud, a hybrid cloud, cloud gaming, cloud education, cloud conferencing, cloud social, an artificial intelligence cloud service, and the like. With the development of the cloud technology and the application of the cloud technology in different fields, an increasing number of cloud applications emerge.

A quantum computer is a machine that performs computing through a principle of quantum mechanics. Based on the superposition principle of quantum mechanics and quantum entanglement, the quantum computer has a relatively strong parallel processing capability and can resolve some problems that are difficult for a classical computer to compute. The zero resistance characteristic of superconducting qubits and a manufacturing process close to that of integrated circuits make a quantum computing system constructed by using the superconducting qubits one of the most promising systems currently for implementing practical quantum computing.

A quantum processing unit is a quantum-level computer processing unit, that is, a processing unit of a quantum computer. The quantum processing unit may include one or more quantum chips.

The quantum chip (or referred to as a superconducting quantum chip) is a central processing unit of the quantum computer, and is a core component of the quantum computer. The quantum chip integrates a quantum line on a substrate, thereby carrying a function of quantum information processing. In view of the development history of conventional computers, after bottlenecks of technologies are overcome in research in the quantum computer, to implement commodity and industrial upgrading, integration is required. Superconducting systems, semiconductor quantum dot systems, micro-nano photonics systems, and even atomic and ion systems all are intended to be developed toward chips. In view of development, the superconducting quantum chip systems are technically ahead of other physical systems; and conventional semiconductor quantum dot systems are also a target of people's efforts to explore because after all, the development of the conventional semiconductor industry is already very mature. For example, once a semiconductor quantum chip breaks through thresholds for fault-tolerant quantum computing in a decoherence time and control precision, it is expected to integrate related efforts of the conventional semiconductor industry, to reduce development costs. In the embodiments of this application, a real quantum chip is referred to as a physical quantum chip.

In view of advantages of the quantum computer, in future systems constructed based on the cloud technology, the quantum computer may be used to perform some processing and computing, to provide better services.

A qubit is a measurement unit in quantum informatics. In both a conventional computer and the quantum computer, 0 and 1 are used to represent information. However, differently, in the quantum computer, the qubit may be both 0 and 1, and this effect is referred to as quantum superposition, and is also a unique characteristic of the quantum computer.

A quantum circuit is an abstract concept, which indicates a line that operates qubits in the quantum computer, and includes representation and lines (timelines) of qubit units, and computations of various quantum logic gates. Finally, quantum measurement usually needs to be used to read out a result.

A quantum gate is a basic quantum circuit in quantum computing that operates a small quantity of qubits. Different from a conventional logic gate, the quantum gate is reversible and may be indicated by using a unitary matrix. The quantum gate includes Hadamard, Pauli-X, Pauli-Y, Pauli-Z, SWAP, CNOT, and the like.

The quantum gate includes a single-bit gate, a two-bit gate, and a multi-bit gate. The single-bit gate is a logic gate acting on a single qubit, the two-bit gate is a logic gate acting on two qubits, and the multi-bit gate is a logic gate acting on a plurality of qubits.

A quantum language is a direction of research in quantum computing. In the field of the quantum language, a standard assembly instruction set is constructed according to logic gate capabilities of the quantum computer, a more advanced computer language can be abstractly constructed continuously, and even the field of classical computer languages can be mixed to form a hybrid language.

Terminal symbol, nonterminal symbol, and derivation rule: The terminal symbol is a basic symbol of a formal language, and may appear in an input or output string of the derivation rule, but cannot be decomposed into fewer units. The nonterminal symbol is a symbol that may be replaced. At least one start symbol is provided in a form method, and necessarily belongs to the nonterminal symbol. The derivation rule is a component that defines a syntax. Usually, there are a plurality of derivation rules, and each rule specifies what word bits can be rewritten into other word bits.

Fidelity is a degree to which a model or a simulation reproduces a condition, a feature, or a state in the real world, and is an indicator for measuring authenticity of the model or the simulation. In quantum mechanics and optics, fidelity of a field is an overlap integration of a field of interest and a target field.

Decoherence (also referred to as quantum decoherence) is an effect in quantum mechanics in which quantum coherence of an open quantum system is gradually lost over time due to quantum entanglement with an external environment. The decoherence makes an interference phenomenon between quanta disappear, so that a quantum behavior of the system is transformed into a classical behavior.

Topology is a discipline that studies some properties of a geometric figure or space that can remain unchanged after a shape is continuously changed. The topology only considers positional relationships between objects without considering shapes and sizes of the objects.

Mapping is a relationship that elements between two sets of elements “correspond” to each other, and is a noun. “Mapping” or “projection”, is often equivalent to a function in mathematics and related fields.

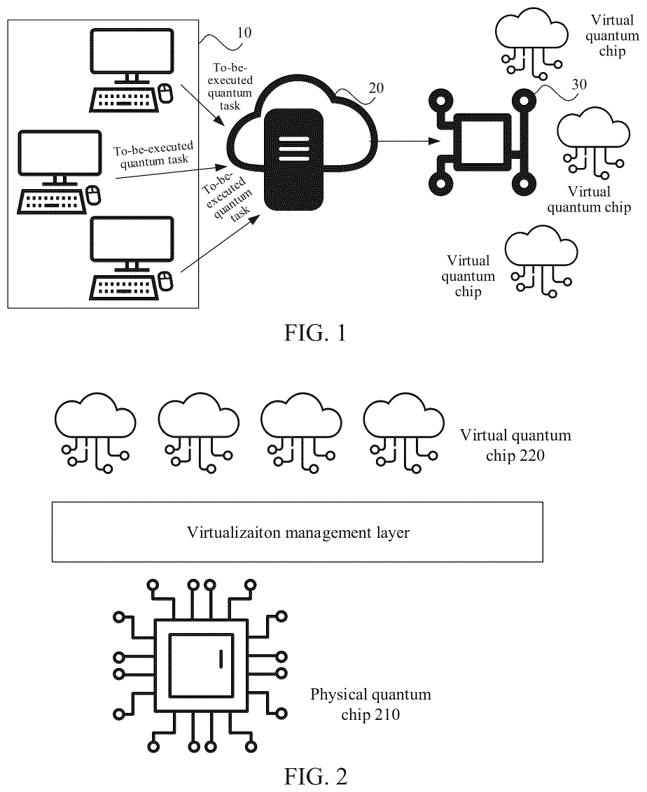

FIG. 1 is a schematic diagram of an implementation environment of a solution according to an exemplary embodiment of this application. The implementation environment of the solution may include a terminal device 10, a cloud server 20, and a quantum computer 30.

The terminal device 10 may be an electronic device such as a personal computer, a tablet computer, a mobile phone, a wearable device, a smart home appliance, or an in-vehicle terminal. An application program is run on the terminal device 10. The application program is configured to provide a quantum task execution function. A user provides a to-be-processed quantum task for the application program, and the application program returns an execution result corresponding to the to-be-processed quantum task to the user.

The cloud server 20 is configured to provide a back-end service for a client of the application program in the terminal device 10. For example, the cloud server 20 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

The cloud server 20 has a data transmitting and receiving function. In an example, the cloud server 20 obtains a target quantum task from the terminal device 10, and the cloud server 20 generates a physical quantum circuit corresponding to the target quantum task, and indicates, through the physical quantum circuit, the quantum computer 30 to execute the quantum task, to obtain an execution result corresponding to the quantum task.

A physical quantum chip is arranged in the quantum computer 30. The physical quantum chip is configured to perform quantum computing, execute the quantum task, and generate the execution result corresponding to the quantum task. In the method, the physical quantum chip is divided into at least two virtual quantum chips (also referred to as virtual quantum processing units (VQPUs)), that is, the physical quantum chip can be mapped to at least two virtual quantum chips. Each of the virtual quantum chips respectively corresponds to a partial structure in the physical quantum chip, and partial structures respectively corresponding to different virtual quantum chips do not include overlapping physical qubits. The quantum computer 30 receives an instruction set corresponding to the physical quantum circuit from the cloud server 20, where physical qubits included in the physical quantum circuit are all present in the partial structures corresponding to the virtual quantum chips in the physical quantum chip.

After obtaining the execution result of the quantum task, the quantum computer 30 sends the execution result of the quantum task to the cloud server 20, and the cloud server 20 sends the execution result of the quantum task to the terminal device 10.

With continuous development of quantum computing, many companies start to release quantum cloud platforms. Quantum clouds are commonly used to provide quantum computing power services. However, because the quantum chips in a current stage are in a noisy intermediate-scale quantum (NISQ) age, the quantum chips currently have high online maintenance costs, and quantities of quantum chips online on the quantum cloud platforms are limited. In addition, the quantum chip is limited by a physical topology thereof. When the quantum chip executes a quantum task, regardless of a size of the quantum task, the quantum task occupies the entire chip, resulting in low utilization of computing resources.

In view of information disclosed by a related quantum cloud platform, a cloud service platform uses a quantum processing unit (QPU) in a mode in which entire hardware is directly invoked for a single quantum task. When a large batch of quantum tasks simultaneously floods the quantum cloud platform, the large batch of quantum tasks needs to be queued, and the quantum tasks are executed one by one by using the physical quantum chip. In this way, long task queue waiting time is required before the user obtains an execution result corresponding to a quantum task, resulting in a decrease in use experience of the user.

In the quantum task execution manner, only launching more quantum chip resources online can improve a response speed for a user task. However, high costs are required to maintain a stable online physical quantum chip. In addition, there is usually no need to invoke resources of the entire physical quantum chip for the single quantum task, and the quantum task execution mode in which the single quantum task occupies the entire physical quantum chip causes a large number of quantum computing resources to be idle and wasted.

FIG. 2 is an exemplary diagram of a quantum task execution method according to an exemplary embodiment of this application.

To overcome an execution mode defect caused by a physical quantum chip being exclusive to a single quantum task, in this application, based on a virtualization idea, a physical quantum chip 210 is segmented into a plurality of virtual quantum chips 220 through a chip bit mapping method. A cloud server provides a virtualization management layer function, so that the plurality of virtual quantum chips 220 have independent interfaces, in other words, the plurality of virtual quantum chips 220 can respectively execute different quantum tasks within the same time period. Through the method, a topology limitation on the physical quantum chip is relieved, and the same physical quantum chip simultaneously executes a plurality of quantum tasks, so that utilization of quantum computing resources can be improved, and an idle waste of the resources can be reduced. Through the method, a quantum cloud platform can configure a different virtual quantum chip according to a user need, to implement a customized user service.

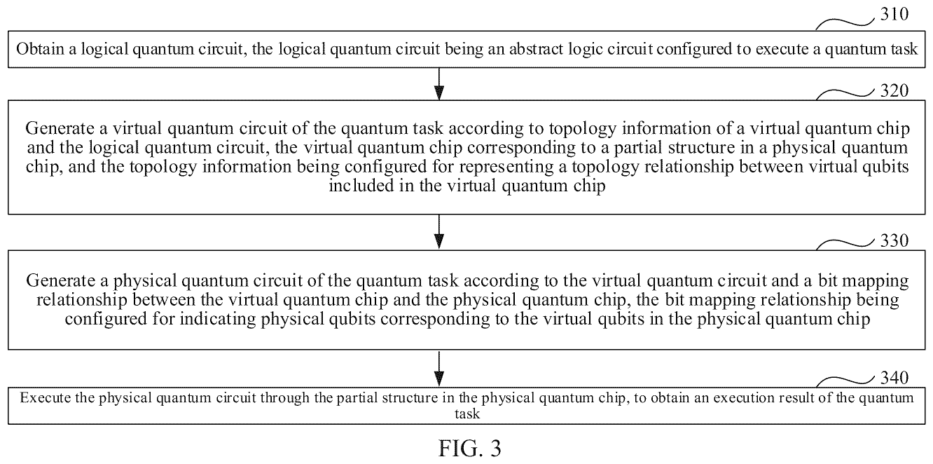

FIG. 3 is a flowchart of a quantum task execution method according to an exemplary embodiment of this application. For example, an execution entity of the method may be the cloud server 20 in FIG. 1. For convenience of description, a computer device is used as the execution entity below to describe the quantum task execution method. As shown in FIG. 3, the method may include the following operation 310 to operation 340.

Operation 310: Obtain a logical quantum circuit, the logical quantum circuit being an abstract logic circuit configured to execute a quantum task.

The quantum task is a to-be-executed task, and the quantum task is a line task that needs to be executed by a physical quantum chip. In one embodiment, a to-be-processed quantum task is a computing task in the field of quantum chemical simulation, quantum artificial intelligence and cryptographic analysis, meteorological forecasting, drug design, financial analysis, oil exploration, or the like.

In some implementations, the target quantum task is from a user of a quantum cloud service. For example, the user sends the target quantum task to the computer device through a terminal device. In one embodiment, the target quantum task is described by using a quantum program. The quantum program corresponding to the to-be-executed task includes logical qubits required by the target quantum task and gate units that need to perform logical operations on the logical qubits. In an example, the computer device obtains the quantum program corresponding to the target quantum task from the terminal device, and obtains the logical quantum circuit of the to-be-executed task according to the quantum program.

In some other embodiments, the computer device can directly obtain the logical quantum circuit of the target quantum task. For example, the user transmits the logical quantum circuit to the computer device, so that the computer device obtains the logical quantum circuit.

The logical quantum circuit belongs to a quantum line, and the logical quantum circuit is a quantum computing model. In some embodiments, the logical quantum circuit includes logical qubits and quantum gates configured to perform logical operations on states of the logical qubits. In one embodiment, the quantum gates in the logical quantum circuit have a timing relationship, and corresponding gate unit operations are performed on the states of logical qubits in the logical quantum circuit according to the timing relationship, so that a process of executing the quantum task can be implemented.

In one embodiment, there is no topology limitation between the logical qubits. To be specific, when a quantum gate operation is performed on more than one logical qubits, there is no need to consider whether the more than one logical qubits have connectivity.

Operation 320: Generate a virtual quantum circuit of the quantum task according to topology information represented by a virtual quantum chip and the logical quantum circuit, the virtual quantum chip corresponding to a partial structure in a physical quantum chip, and the topology information of the virtual quantum chip being configured for representing a topology relationship between virtual qubits included in the virtual quantum chip.

The virtual quantum circuit is a circuit constructed based on the virtual qubits. For example, the virtual quantum circuit is a circuit that is configured to execute the quantum task and constructed based on the virtual qubits.

The physical quantum chip is a real quantum chip, and execution of the quantum task is completed through the physical quantum chip. For example, logical operations are performed on physical qubits included in the physical quantum chip through gate units, and then states of the physical qubits are observed to obtain the execution result of the quantum task.

It can be learned from the foregoing introduction to the background technologies that, in the related art, due to a limitation on the topology information of the physical quantum chip, the physical quantum chip can execute only one quantum task at a time, resulting in a large waste of computing resources. In the method, the physical quantum chip is segmented into a plurality of virtual quantum chips. Each of the virtual quantum chips corresponds to a partial structure in the physical quantum chip, and there is no overlapping relationship between partial structures respectively corresponding to different virtual quantum chips in the physical quantum chip. That “the physical quantum chip is segmented into a plurality of virtual quantum chips” may be understood as establishing a mapping relationship between partial structures in the physical quantum chip and the virtual quantum chips.

In one embodiment, the virtual quantum chip is mapping of the partial structure in the physical quantum chip. The virtual quantum chip includes virtual qubits, and there is a mapping between the virtual qubits and physical qubits included in the partial structure in the physical quantum chip.

In some embodiments, a quantity of virtual qubits included in the virtual quantum chip is related to a quantity of physical qubits included in the partial structure to which the virtual quantum chip is mapped. For example, the quantity of physical qubits included in the virtual quantum chip is less than or equal to the quantity of physical qubits included in the partial structure to which the virtual quantum chip is mapped.

For example, a virtual quantum chip corresponds to a partial structure 1 in the physical quantum chip, where the partial structure 1 includes ten physical qubits, and the virtual quantum chip includes ten virtual qubits. For another example, a virtual quantum chip corresponds to a partial structure 2 in the physical quantum chip, where the partial structure 2 includes six physical qubits, and the virtual quantum chip includes five virtual qubits.

In one embodiment, the topology information of the virtual quantum chip is consistent with topology information of the partial structure corresponding to the virtual quantum chip in the physical quantum chip. To be specific, arrangement of the virtual qubits in the virtual quantum chip is the same as arrangement of the physical qubits in the partial structure corresponding to the virtual quantum chip in the physical quantum chip; and connectivity between the virtual qubits in the virtual quantum chip is consistent with connectivity between the physical qubits in the partial structure in the physical quantum chip.

For example, there is a mapping between a virtual qubit 1 and a physical qubit 1, and there is a mapping between a virtual qubit 2 and a physical qubit 2. If the physical qubit 1 and the physical qubit 2 have connectivity, the virtual qubit 1 and the virtual qubit 2 have connectivity.

For a process of establishing the mapping relationship between the virtual quantum chips and the partial structures in the physical quantum chip, refer to the following embodiments.

In the field of quantum computing, the topology information represents whether qubits have connectivity that is not affected by positions and can interact with each other. In one embodiment, the topology information is configured for representing that at least two qubits have a connection association relationship, which is also referred to as connectivity. For example, for any two qubits having connectivity, states of the two qubits can interact with each other (for example, through a quantum gate operation, the states of the two qubits affect each other); and for any two qubits having no connectivity, states of the two qubits cannot directly affect each other. In one embodiment, the foregoing qubits include virtual qubits or physical qubits.

From a perspective of a hardware structure, for two physical qubits having connectivity in the physical quantum chip (namely, the real quantum chip), elements such as couplers are arranged between lines of the two physical qubits, and interaction between states of the two physical qubits is realized through the elements.

In some embodiments, the topology information of the virtual quantum chip includes connectivity between any two virtual qubits in the virtual quantum chip. In one embodiment, connectivity between virtual qubits is indicated by using one bit character, where “1” indicates that two virtual qubits have connectivity, and “0” indicates that two virtual qubits have no connectivity.

For example, for a virtual qubit 1 and a virtual qubit 2 in a virtual quantum chip, in topology information of the virtual quantum chip, if the virtual qubit 1 and the virtual qubit 2 correspond to the bit character “1”, it indicates that the virtual qubit 1 and the virtual qubit 2 have connectivity; and if the virtual qubit 1 and the virtual qubit 2 correspond to the bit character “0”, it indicates that the virtual qubit 1 and the virtual qubit 2 have no connectivity.

In some embodiments, the physical quantum chip corresponds to a plurality of virtual quantum chips. After the computer device obtains the logical quantum circuit corresponding to the target quantum task, the computer device determines a virtual quantum chip configured to execute the foregoing quantum task from at least one candidate virtual quantum chip, and determines topology information of the virtual quantum chip, to generate the virtual quantum circuit of the quantum task according to the logical quantum circuit and the topology information of the virtual quantum chip.

In one embodiment, that the computer device determines a virtual quantum chip configured to execute the foregoing quantum task from at least one candidate virtual quantum chip includes: determining, according to the topology information of the virtual quantum chip, the virtual quantum chip configured to execute the quantum task from the at least one candidate virtual quantum chip. In one embodiment, the selected virtual quantum chip is a virtual quantum chip that can execute the quantum task. For example, a topology relationship between virtual qubits included in the selected virtual quantum chip conforms to the logical quantum circuit. In other words, when there is a topology limitation between the virtual qubits, the selected virtual quantum chip can realize the logical quantum circuit. For example, it is assumed that the logical quantum circuit includes only a logical qubit 1 and a logical qubit 2, the logical qubit 1 and the logical qubit 2 require a quantum gate to perform a logical operation at a first moment, a virtual qubit 1 corresponds to a logical qubit 1, a virtual qubit 2 corresponds to a logical qubit 2, and the virtual qubit 1 and the virtual qubit 2 have connectivity. In this case, it indicates that the topology relationship between the virtual qubits included in the virtual quantum chip conforms to the logical quantum circuit. In one embodiment, when the computer device determines the virtual quantum chip configured to execute the quantum task from the at least one candidate virtual quantum chip, the computer device determines the virtual quantum chip configured to execute the quantum task according to a virtual quantum chip indication corresponding to the target quantum task.

For example, the virtual quantum chip indication is from the user that provides the quantum task. In other words, the computer device supports the user in selecting, according to an actual need, the virtual quantum chip configured to execute the quantum task. Selecting a different virtual quantum chip to execute a quantum task means using a different partial structure in the physical quantum chip to execute the quantum task. Because physical qubits at different positions in the physical quantum chip have different reliability, the physical quantum chip is segmented into the plurality of virtual quantum chips, so that different virtual quantum chips have different computing characteristic. This is convenient for the user to select a corresponding virtual quantum chip according to an actual need, to implement a customized user service.

In some embodiments, the virtual quantum circuit belongs to a quantum line. In one embodiment, the virtual quantum circuit includes virtual qubits and gate units configured to perform logical operations on the virtual qubits. The gate units have execution timing.

In one embodiment, the gate unit in the virtual quantum circuit conforms to the topology information of the virtual quantum chip. By using a two-quantum gate configured to perform logical processing on two virtual qubits as an example, the two virtual qubits inputted into the two-quantum gate need to have connectivity.

In some embodiments, In the operation of generating a virtual quantum circuit of the quantum task according to topology information of a virtual quantum chip and the logical quantum circuit, it is mainly necessary to convert the logical qubits in the logical quantum circuit into virtual qubits, and determine, according to the topology information of the virtual quantum chip, how to convert the gate units in the logical quantum circuit into gate units that conform to a topology relationship between the virtual qubits. For implementation content of the operation, refer to the following embodiments.

Operation 330: Generate a physical quantum circuit of the quantum task according to the virtual quantum circuit and a bit mapping relationship between the virtual quantum chip and the physical quantum chip, the bit mapping relationship being configured for indicating physical qubits corresponding to the virtual qubits in the physical quantum chip.

The physical quantum circuit is a circuit constructed based on the physical qubits. For example, the physical quantum circuit is a circuit that is configured to execute the quantum task and constructed based on the physical qubits.

In some embodiments, the physical quantum circuit includes physical qubits and gate units configured to perform logical processing on the physical qubits. The physical quantum chip runs according to the physical quantum circuit, which is equivalent to executing the quantum task and finally generating the execution result of the quantum task.

In some embodiments, the bit mapping relationship is configured for determining the physical qubits corresponding to the virtual qubits from the physical quantum chip. In one embodiment, that the computer device generates a physical quantum circuit of the quantum task according to the virtual quantum circuit and a bit mapping relationship between the virtual quantum chip and the physical quantum chip includes: determining the physical qubits corresponding to the virtual qubits in the virtual quantum circuit according to the bit mapping relationship, and replacing the virtual qubits in the virtual quantum circuit with the physical qubits, to obtain the physical quantum circuit. For related content of the process, refer to the following embodiments.

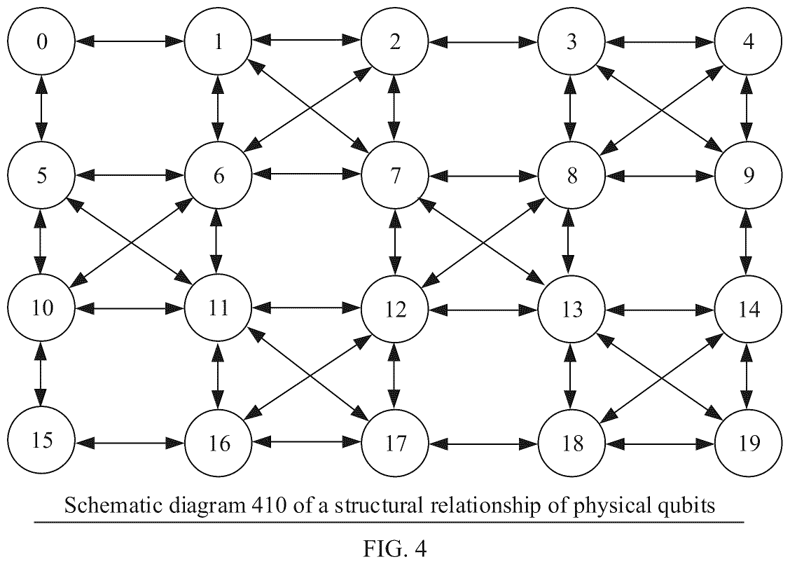

FIG. 4 is a schematic diagram 410 of a structural relationship of physical qubits according to an exemplary embodiment of this application. A bidirectional arrow in the figure identifies that two physical qubits have connectivity. For example, in FIG. 4, a physical qubit q[0] and a physical qubit q[1] have connectivity, and the physical qubit q[0] and a physical qubit q[6] have no connectivity. A topology relationship of the physical qubits is related to a hardware structure of the physical quantum chip. In one embodiment, the topology relationship of the physical qubits cannot be changed.

Operation 340: Execute the physical quantum circuit through the partial structure in the physical quantum chip, to obtain the execution result of the quantum task.

In one embodiment, after generating the physical quantum circuit of the physical quantum chip, the computer device generates an instruction set corresponding to the physical quantum circuit, and sends the instruction set to the physical quantum chip. The physical quantum chip perform execution according to an instruction of the instruction set, and can generate the execution result of the quantum task, and the physical quantum chip sends the execution result of the quantum task to the computer device.

In some embodiments, the execution result of the quantum task is a result obtained by the physical quantum chip performing quantum computing on the quantum task.

In conclusion, compared with a method in which a physical quantum chip executes one quantum task at a time in the related art, in this application, a physical quantum chip is segmented, so that the physical quantum chip corresponds to a plurality of virtual quantum chips that do not interfere with each other. A virtual quantum chip is selected after a target quantum task is obtained, so that a partial structure corresponding to the selected virtual quantum chip in the physical quantum chip participates in a process of executing the quantum task according to a bit mapping relationship, to ensure that other structures other than the partial structure in the physical quantum chip do not participate in the process of executing the quantum task. In this way, physical qubits used in the process of executing the quantum task are controllable, and the other structures are also allowed to execute other quantum tasks within the same time period.

Through the method, parallel execution of a plurality of quantum tasks is realized, so that efficiency of executing the quantum tasks can be improved, a response speed of feeding back execution results of the quantum tasks can be improved, and computing resources can be reduced. In addition, through the method, one physical quantum chip serves as a plurality of quantum chips for use, so that a quantity of physical quantum chips that need to be maintained can be reduced when increasing quantum tasks are flexibly adapted to, thereby reducing maintenance costs of the physical quantum chips.

The following describes a process of generating the logical quantum circuit through several embodiments. An execution entity of the operation is the computer device.

In some embodiments, the obtaining a logical quantum circuit in operation 310 may further include the following several sub-operations (not shown in the accompanying drawings in this specification).

Sub-operation 312: Obtain task indication information, the task indication information being configured for indicating the target quantum task.

In one embodiment, the task indication information is configured for indicating logical qubits and gate units configured to perform operations on the logical qubits. In some embodiments, the task indication information is a quantum program, the quantum program includes at least one row of program instructions, and the program instructions are configured for instructing a virtual qubit on which a logical operation is performed. In one embodiment, the computer device receives the task indication information sent by the terminal device. In one embodiment, the computer device obtains the task indication information through an external input device.

Sub-operation 314: Determine, for any one of operation indications included in the task indication information, a first gate unit corresponding to the operation indication and at least one logical qubit on which the first gate unit is configured to perform logical processing.

In some embodiments, the operation indication is configured for indicating an operation of the first gate unit, and the first gate unit is a quantum gate configured to perform a logical operation on the logical qubit. The first gate unit may be one quantum gate or a combination of a plurality of quantum gates. For related content of the first gate unit, refer to the following embodiments.

When the task indication information is the quantum program, the operation indication is any one of program instructions in the quantum program, and the program instruction includes the first gate unit and a logical qubit on which the first gate unit is configured to perform a logical operation. For example, a program instruction may be indicated as: H q[0], where q[0] indicates a logical qubit 0, and H indicates that the first gate unit is an H gate.

In one embodiment, different first gate units have different functions, and a state of the logical qubit changes after processing by the first gate unit.

For example, different first gate units are configured to perform logical operations on logical qubits at different moments, there is timing of the first gate units, and in the process of generating the logical quantum circuit, the first gate units need to be arranged according to the timing of the first gate units.

Sub-operation 316: Perform, according to timing information of the operation indications included in the task indication information, timing association on the first gate units respectively corresponding to the operation indications, to generate the logical quantum circuit of the quantum task.

In some embodiments, the timing information is configured for representing execution orders of the first gate units corresponding to the operation indications. For example, when the task indication information is the quantum program, arrangement orders of the program instructions in the quantum program are configured for representing timing information of the first gate units. Timing of a program instruction arranged above in the quantum program takes precedence over timing of a program instruction arranged below in the quantum program.

For example, the quantum program includes a program instruction 1, a program instruction 2, a program instruction 3, and a program instruction 4 from top to bottom. In this case, an execution order of a first gate unit 1 corresponding to the program instruction 1 takes precedence over an execution order of a first gate unit 2 corresponding to the program instruction 2, the execution order of the first gate unit 2 corresponding to the program instruction 2 takes precedence over an execution order of a first gate unit 3 corresponding to the program instruction 3, and the execution order of the first gate unit 3 corresponding to the program instruction 3 takes precedence over an execution order of a first gate unit 4 corresponding to the program instruction 4. In other words, execution timing of the foregoing four first gate units is the first gate unit 1, the first gate unit 2, the first gate unit 3, and the first gate unit 4 respectively. Based on this, a logical operation by the second gate unit 2 is performed only after a logical operation by the first gate unit 1 is completed, and then a logical operation by the first gate unit 3 and a logical operation by the first gate unit 4 are sequentially performed. In one embodiment, the execution orders of the first gate units cannot be swapped.

That the computer device performs timing association on the first gate units respectively corresponding to the operation indications may be understood as follows: Set arrangement positions of the first gate units in the logical quantum circuit according to the timing information, to ensure that a first gate unit with later timing occurs later than a first gate unit with earlier timing. In one embodiment, an order of quantum lines from left to right in the logical quantum circuit represents timing, and execution timing of a first gate unit located on the left is earlier than execution timing of a first gate unit located on the right.

In some embodiments, timing association is performed on the first gate units respectively corresponding to the operation indications, to generate the logical quantum circuit of the quantum task by using logical qubits.

In one embodiment, at least one logical qubit respectively corresponding to each of a plurality of first gate units is sequentially determined according to timing information of the plurality of first gate units, and the at least one logical qubit respectively corresponding to each of the plurality of first gate units is associated when timing association is performed on the plurality of first gate units, to generate the logical quantum circuit.

In the foregoing content, content of generating the logical quantum circuit according to the task indication information is described. The task indication information represents logical qubits that needs logical processing and gate units, and the task indication information is converted into the logical quantum circuit, so that the objective of automatically generating the logical quantum circuit according to a timing relationship of the operation indications is achieved, and efficiency of generating the logical quantum circuit can be improved. In addition, through the method, the user does not need to provide a logical quantum circuit, and a logical quantum circuit easier to be executed by the computer device can be flexibly generated as long as task indication information having specific instruction information is provided. This can reduce a threshold for the user to obtain the execution result of the quantum task, and greatly avoid a bias in the execution result because the user provides a wrong logical quantum circuit, thereby improving accuracy of the execution result.

The following describes a process of generating the virtual quantum circuit through several embodiments. An execution entity of the operation is the computer device.

Because the virtual quantum circuit includes the virtual qubits and the gate units configured to process the virtual qubits, the gate units included in the virtual quantum circuit need to be determined in the process of generating the virtual quantum circuit; and then the gate units are arranged according to the timing relationship.

In some embodiments, the generating a virtual quantum circuit of the quantum task according to topology information represented by a virtual quantum chip and the logical quantum circuit in operation 320 further includes the following several sub-operations.

Sub-operation 322: Determine, according to the topology information of the virtual quantum chip, second gate units respectively corresponding to first gate units in the logical quantum circuit, the first gate units being quantum gates configured to perform logical processing on logical qubits in the logical quantum circuit, and the second gate units being quantum gates configured to perform the same logical processing on the virtual qubits as the first gate units.

Sub-operation 322 is mainly configured to determine the second gate units respectively corresponding to the first gate units of the logical quantum circuit in the virtual quantum circuit. In one embodiment, the first gate unit and the second gate unit have the same function. That is, the first gate unit and the second gate unit are configured to implement the same logical operation.

In some embodiments, a gate unit includes at least one quantum gate. For example, the gate unit is a single quantum gate, or the gate unit includes a plurality of quantum gates. For example, the gate unit includes a plurality of quantum gates successively executed in timing. In one embodiment, a type of the quantum gate includes, but is not limited to, at least one of the following: a single-bit gate, a two-bit gate, or a multi-bit gate.

The single-bit gate is a quantum gate configured to perform a logical operation on a single qubit. The two-bit gate is a quantum gate configured to perform a logical operation on two qubits. States of the two qubits are inputted into the two-bit gate, and states of the two qubits after logical processing are outputted.

The multi-bit gate is a quantum gate configured to perform an operation on a plurality of qubits, and the multi-bit gate may be obtained by combining a two-bit gate and/or a single-bit gate. For example, a multi-bit gate may be decomposed into three single-bit gates, and another multi-bit gate may be decomposed into one two-bit gate and one single-bit gate.

In some embodiments, the first gate unit is any gate unit included in the logical quantum circuit. In one embodiment, the first gate unit is a single-bit gate or a two-bit gate. For example, the first gate unit is a Hadamard (H) gate, where the H gate is configured to convert a states of a qubit into a superposed state. For another example, the first gate unit is a Controlled NOT (CNOT) gate, to convert two qubits into entangled qubits.

In some embodiments, the second gate unit is a gate unit corresponding to the first gate unit in the virtual quantum circuit. In one embodiment, timing of the second gate unit in the virtual quantum circuit is the same as timing of the first gate unit in the logical quantum circuit.

In one embodiment, the second gate unit is configured to implement the same logical operation as the first gate unit. For example, a state of a logical qubit inputted into the first gate unit is the same as a state of a virtual qubit inputted into the second gate unit, and a state of a logical qubit outputted by the first gate unit is the same as a state of a virtual qubit outputted by the second gate unit. A quantity of quantum gates included in the second gate unit is greater than or equal to a quantity of quantum gates included in the first gate unit.

For example, the second gate unit is the same as the first gate unit. For example, when the first gate unit is a single-bit gate, the second gate unit is the same as the first gate unit. Assuming that the first gate unit is an H gate, the second gate unit is also an H gate.

For example, the second gate unit is different from the first gate unit. It can be learned from the foregoing that, logical qubits have no topology relationship, which is equivalent to default to that any two logical qubits have connectivity. Therefore, the first gate unit in the logical quantum circuit may perform a logical operation on any one or more logical qubits.

The virtual quantum chip has topology information. To be specific, some virtual qubits included in the virtual quantum chip have a topology relationship, and the other virtual qubits have no topology relationship. If virtual qubits corresponding to the plurality of (at least two) logical qubits on which the first gate unit is configured to perform the logical operation have no connectivity, states of the virtual qubits need to be first swapped to other virtual qubits by using a quantum gate, and then the first gate unit performs the corresponding logical operation on the other virtual qubits, to achieve an effect that the first gate unit and the second gate unit have the same function.

Since the quantum gates for state conversion is newly added to achieve the same effect as the first gate unit, in this case, the quantity of quantum gates included in the second gate unit is greater than the quantity of quantum gates included in the first gate unit. For example, the second gate unit includes at least one swap gate unit and a gate unit of the same type as the first gate unit.

In some embodiments, that the computer device determines, according to the topology information of the virtual quantum chip, second gate units respectively corresponding to first gate units in the logical quantum circuit includes: determining a virtual qubit corresponding to the first gate unit; when the first gate unit corresponds to a plurality of virtual qubits, determining, according to the topology information of the virtual quantum chip, a topology relationship between the plurality of virtual qubits (that is, whether the plurality of virtual qubits have connectivity); and determining the second gate unit corresponding to the first gate unit according to a determining result. For related content of the operation, refer to the following embodiments.

Sub-operation 324: Generate the virtual quantum circuit of the quantum task according to the second gate units respectively corresponding to the first gate units and a timing relationship of the first gate units in the logical quantum circuit.

In some embodiments, the timing relationship of the first gate units in the logical quantum circuit is configured for representing execution orders of the first gate units in the logical quantum circuit. In one embodiment, the timing relationship of the first gate units in the logical quantum circuit is determined by the computer device according to arrangement positions of the first gate units in the logical quantum circuit. For example, in the logical quantum circuit, the first gate units are arranged from left to right. Execution timing of a first gate unit closer to the left is earlier, and execution timing of a first gate unit closer to the right is later.

After the second gate units respectively corresponding to the first gate units are determined, it is equivalent to that all gate units forming the virtual quantum circuit are obtained. The cloud server determines a timing relationship of the second gate units according to the timing relationship of the first gate units in the logical quantum circuit, and arranges the second gate units according to the timing relationship, to generate the virtual quantum circuit of the quantum task.

For example, execution timing of the second gate units is the same as execution timing of the first gate units. For example, the logical quantum circuit includes three first gate units adjacent in execution timing: a first gate unit 1, a first gate unit 2, and a first gate unit 3, where execution timing of the first gate unit 1 is earliest, and the first gate unit 2 is executed between the first gate unit 1 and the first gate unit 3. It is assumed that the computer device determines that the first gate unit 1 corresponds to a second gate unit 1, the first gate unit 2 corresponds to a second gate unit 2, and the first gate unit 3 corresponds to a second gate unit 3. In this case, in the virtual quantum circuit, the second gate unit 1, the second gate unit 2, and the second gate unit 3 are three second gate units adjacent in execution timing, where execution timing of the second gate unit 1 is earliest, and the second gate unit 2 is executed between the second gate unit 1 and the second gate unit 3.

In the foregoing process, the content of generating the virtual quantum circuit according to the topology relationship represented by the virtual quantum chip is described. The second gate units respectively corresponding to the first gate units are determined according to the topology information of the virtual quantum chips, to convert, according to the timing relationship of the first gate units in the logical quantum circuit, the logical quantum circuit into the virtual quantum circuit adapted to the topology information of the virtual quantum chip through the second gate units, thereby avoiding the execution of the quantum task directly through an arbitrarily obtained logical quantum circuit. Based on the logical quantum circuit corresponding to the quantum task, the virtual quantum circuit is generated layer by layer according to the topology information of the virtual quantum chip, so that the virtual quantum chip executes the virtual quantum circuit, in other words, the objective of controlling a partial structure in the physical quantum chip to smoothly execute the quantum task in subsequent operations is achieved, and pertinence of executing the quantum task through the partial structure in the physical quantum chip is improved.

The following describes a process of generating the second gate unit through several embodiments. An execution entity of the operation is the computer device.

In the process of determining the second gate units corresponding to the first gate units, methods for generating the second gate units may be classified according to types of the first gate units. Methods for generating second gate units corresponding to different types of first gate units are not exactly the same. In one embodiment, the type of the first gate unit is related to a quantity of logical qubits on which the first gate unit configured to perform logical processing.

The following mainly describes, through several embodiments, a case in which the first gate unit is a single-bit gate and a case in which the first gate unit is a two-bit gate. When the first gate unit is a multi-bit gate, because the multi-bit gate may be implemented by a combination of at least one of a two-bit gate or a single-bit gate (for example, a function of a three-quantum gate may be implemented by a combination of one two-bit gate and one single-bit gate), the multi-bit gate may be decomposed into a single-bit gate and a two-bit gate, that is, the first gate unit is decomposed into at least two first sub-units, and the first sub-units are used as new first gate units. Through methods in the following embodiments, second gate units respectively corresponding to the first sub-units are determined, and timing association is performed on the second gate units respectively corresponding to the first sub-units, to generate the second gate units corresponding to the first gate units. In one embodiment, a multi-bit gate decomposition method includes: predicting an equivalent gate combination of the multi-bit gate, testing the multi-bit gate and the equivalent gate combination, and using the equivalent gate combination as the multi-bit gate when the testing passes. For related content of the method, refer to technologies related to multi-bit gate decomposition. This is not limited in this application.
Example 1: Content of determining the second gate unit corresponding to the first gate unit when the first gate unit is a two-bit gate is described.

In some embodiments, the determining, according to the topology information of the virtual quantum chip, second gate units respectively corresponding to first gate units in the logical quantum circuit in sub-operation 322 further includes the following several sub-operations.

Sub-operation 322-a: For any one of the first gate units, determine, according to the topology information of the virtual quantum chip when the first gate unit is configured to perform logical processing on a first logical qubit and a second logical qubit, first information configured for representing a connection association relationship between a first virtual qubit and a second virtual qubit, the first virtual qubit corresponding to the first logical qubit, and the second virtual qubit corresponding to the second logical qubit; and
the connection association relationship being configured for representing a connectivity situation between the first virtual qubit and the second virtual qubit. For example, the connection association relationship includes: The first virtual qubit and the second virtual qubit have connectivity; or the first virtual qubit and the second virtual qubit have no connectivity.

In some embodiments, the first logical qubit and the second logical qubit are two different logical qubits. The first logical qubit and the second logical qubit are configured for representing two logical qubits on which the first gate unit is configured to perform a logical operation in the logical quantum circuit. Logical qubits on which different first gate units are configured to perform logical operations may be the same or may be different.

For any first gate unit belonging to a two-bit gate in the logical quantum circuit, the first gate unit performs a logical operation on a state of a first logical qubit and a state of a second logical qubit at the same moment.

In some embodiments, the first virtual qubit is a virtual qubit corresponding to the first logical qubit in the virtual quantum circuit, and the second virtual qubit is a virtual qubit corresponding to the second logical qubit in the virtual quantum circuit. It can be learned from the foregoing descriptions that, there is no topology limitation between logical qubits, and there is a topology limitation between virtual qubits. In other words, the first virtual qubit is the first logical qubit subject to a topology limitation, and the second virtual qubit is the second logical qubit subject to a topology limitation.

The first gate unit may be arranged between the first logical qubit and the second logical qubit without considering a topology relationship between the first logical qubit and the second logical qubit, but whether the gate unit can be directly arranged between the first virtual qubit and the second virtual qubit needs to be determined according to a topology relationship between the first virtual qubit and the second virtual qubit. Therefore, the second gate unit corresponding to the first gate unit needs to be determined according to the topology information.

In some embodiments, the logical quantum circuit includes a plurality of logical qubits. To identify different logical qubits, each logical qubit has identification information, and the identification information is configured for uniquely identifying the logical qubit. For example, the identification information is a number of the logical qubit. For example, if a number of a logical qubit is 0, the logical qubit may be indicated as q[0]; and if a number of a logical qubit is 1, the logical qubit may be indicated as q[1]. The rest can be deduced by analogy.

Similarly, to identify the virtual qubits, each virtual qubit also has identification information, and the identification information may be a number of the virtual qubit.

In one embodiment, there is a correspondence between identification information of a logical qubit and identification information of a virtual qubit corresponding to the logical qubit. For example, the logical qubit and the virtual qubit corresponding to the logical qubit have the same number. For example, q[0] indicates the logical qubit 0 in the logical quantum circuit, and q[0] indicates a virtual qubit 0 in the virtual quantum circuit.

In an example, the computer device determines the first virtual qubit corresponding to the first logical qubit according to identification information of the first logical qubit, and determines the second virtual qubit corresponding to the second logical qubit according to identification information of the second logical qubit; and the computer device determines, from the topology information of the virtual quantum chip, whether the first virtual qubit and the second virtual qubit have the connectivity, to generate the first information.

In one embodiment, the first information is configured for representing the connection association relationship between the first virtual qubit and the second virtual qubit. Because the connection association relationship is configured for representing existence of connectivity, the first information may also be referred to as information configured for representing whether the first virtual qubit and the second virtual qubit have connectivity. For example, the first information may be indicated by using one bit character, where “0” indicates that the first virtual qubit and the second virtual qubit have no connectivity, and “1” indicates that the first virtual qubit and the second virtual qubit have connectivity. The first information is configured for determining the method for generating the second gate unit.

Sub-operation 322-b: Determine the second gate unit corresponding to the first gate unit according to the first information. When the first gate unit is the two-bit gate, the computer device determines the method for generating the second gate unit according to the first information.

For example, when the first information represents that the first virtual qubit and the second virtual qubit have the connectivity, the computer device determines that a quantum gate can be directly arranged between the first virtual qubit and the second virtual qubit, where the quantum gate has the same type as the first gate unit.

For example, when the first information represents that the first virtual qubit and the second virtual qubit have no connectivity, the computer device determines that the quantum gate cannot be directly arranged between the first virtual qubit and the second virtual qubit. For related content of the process, refer to next embodiment.

Through the foregoing method, when the first gate unit is the two-bit gate, the method for generating the second gate unit is determined according to the topology information, so that the generated second gate unit conforms to the topology limitation between the virtual qubits.

In the foregoing sub-operation 322-a and sub-operation 322-b, it is described that when the logical qubits on which the first gate unit performs logical processing include the first logical quantum and the second logical qubit, the first information representing whether the first virtual qubit and the second virtual qubit have the connectivity needs to be determined according to the topology relationship of the virtual quantum chip, to differentially determine, according to a difference of the connectivity represented by the first information, the second gate unit corresponding to the first gate unit according to the first information. Considering that the second gate unit is configured to generate the virtual quantum circuit executed by the virtual quantum chip and the virtual quantum chip corresponds to the physical quantum chip configured to execute the quantum task, the second gate unit needs to accurately represent the logical processing process, and the first information representing connectivity between different virtual qubits is used as a limiting condition for generating the second gate unit. This facilitates obtaining a more accurate second gate unit, so that accuracy of generating the virtual quantum circuit can be improved.
Case 1: The first virtual qubit and the second virtual qubit have the connectivity.

That the computer device determines the second gate unit corresponding to the first gate unit according to the first information includes: determining the first gate unit as the second gate unit if the first information represents that the first virtual qubit and the second virtual qubit have the connectivity.

If the first virtual qubit and the second virtual qubit have the connectivity, it indicates that the quantum gate can be directly established between the first virtual qubit and the second virtual qubit. Therefore, the computer device determines the first gate unit as the second gate unit. For example, if the first gate unit is a CNOT gate, the computer device also determines the second gate unit as the CNOT gate, where the first gate unit is configured to perform CONT logical processing on the first logical qubit and the second logical qubit, and the second gate unit is configured to perform CONT logical processing on the first virtual qubit and the second virtual qubit.
Case 2: The first virtual qubit and the second virtual qubit have no connectivity.

That the computer device determines the second gate unit corresponding to the first gate unit according to the first information includes: determining, if the first information represents that the first virtual qubit and the second virtual qubit have no connectivity, a state swapping link according to the topology information of the virtual quantum chip, the state swapping link being configured for swapping a state of at least one of the first virtual qubit or the second virtual qubit; determining at least one swap gate unit according to the state swapping link; and determining an equivalent gate unit obtained by combining the at least one swap gate unit and the first gate unit as the second gate unit, the swap gate unit being configured to swap states respectively possessed by two qubits inputted into the swap gate unit, and operation timing of the swap gate unit taking precedence over operation timing of the first gate unit in the equivalent gate unit.

For example, if the first virtual qubit and the second virtual qubit have no connectivity, it indicates that the first physical qubit corresponding to the first virtual qubit and the second physical qubit corresponding to the second virtual qubit have no connectivity in the physical quantum chip. If the virtual quantum circuit includes a quantum gate between the first virtual qubit and the second virtual qubit and the physical quantum circuit is generated according to the virtual quantum circuit, a logical operation corresponding to the quantum gate cannot be performed between the first physical qubit and the second physical qubit in the physical quantum chip, resulting in failure in execution of the quantum task.

In this case, the computer device needs to swap a state of the first virtual qubit (or the second virtual qubit) with a state of another virtual qubit. After the state swapping is completed, a logical operation is performed on the another virtual qubit. Quantum gates required in the process are combined in timing to obtain the equivalent gate unit. In one embodiment, the equivalent gate unit includes at least two quantum gates.

In some embodiments, the state swapping link is configured to swap a state of a target virtual qubit with a state of another virtual qubit in the virtual quantum chip, and after the state swapping is completed, the another virtual qubit obtains the state of the target virtual qubit. The target virtual qubit is any one of the first virtual qubit and the second virtual qubit, and the another virtual qubit is a virtual qubit other than the first virtual qubit and the second virtual qubit in the plurality of virtual qubits. For example, the target virtual qubit is a first virtual qubit q[0], and the another virtual qubit is indicated as q[3]. After the state swapping is completed, a state of q[3] is converted into a state of q[0] before the state swapping.

In one embodiment, the state swapping link includes at least one virtual qubit including the target virtual qubit and a state swapping direction, where the state swapping direction is configured for indicating a direction in which state swapping is performed on the at least one virtual qubit. Any two adjacent virtual qubits included in the state swapping link have connectivity.

For example, when the state swapping link includes a plurality of virtual qubits, the target virtual qubit is at a first bit of the state swapping link, and the state swapping direction is configured for indicating to start state swapping from the target virtual qubit, so that the state of the target virtual qubit is swapped to a last virtual qubit in the state swapping link.

For example, if a state swapping link is [target virtual qubit, virtual qubit 3, virtual qubit 5, virtual qubit 7], it indicates that the target virtual qubit and the virtual qubit 3 have connectivity, the virtual qubit 3 and the virtual qubit 5 have connectivity, and the virtual qubit 5 and the virtual qubit 7 have connectivity. In other words, three times of state swapping may be performed, so that the state of the target virtual qubit before the state swapping is referred to as a state of the virtual qubit 7.

The virtual qubits included in the state swapping link all belong to the virtual quantum chip configured to execute the quantum task. In this way, the quantum task can be executed through the partial structure in the physical quantum chip.

In some embodiments, that the computer device determines a state swapping link according to the topology information of the virtual quantum chip includes: determining a first link qubit having connectivity with the target virtual quantum chip according to the topology information of the virtual quantum chip, and determining a second link qubit having connectivity with the first link qubit according to the topology information of the virtual quantum chip; generating, if the second link qubit is the second virtual qubit, the state swapping link according to the first virtual qubit, the at least one link qubit determined in a search process, and the second virtual qubit; using, if the second link qubit is not the second virtual qubit, the second link qubit as the first link qubit, and repeatedly performing the operations starting from the determining a second link qubit having connectivity with the first link qubit according to the topology information of the virtual quantum chip; and dividing the state swapping link, to obtain a first state swapping link including the first virtual qubit and a second state swapping link including the second virtual qubit, a last virtual qubit in the first state swapping link and a last virtual qubit in the second state swapping link having connectivity. The first link qubit and the second link qubit described above are virtual qubits included in the state swapping link.

For example, the state swapping link determined by the computer device is [first virtual qubit, virtual qubit 1, virtual qubit 2, virtual qubit 3, virtual qubit 4, second virtual qubit]. The computer device performs division between the virtual qubit 2 and the virtual qubit 3 in the state swapping link, to obtain the first state swapping link: [first virtual qubit, virtual qubit 1, virtual qubit 2], and the second state swapping link: [second virtual qubit, virtual qubit 4, virtual qubit 3].

In the foregoing example, the computer device may further perform division between the virtual qubit 1 and the virtual qubit 2 in the state swapping link, to obtain the first state swapping link: [first virtual qubit, virtual qubit 1], and the second state swapping link: [second virtual qubit, virtual qubit 4, virtual qubit 3, virtual qubit 2].

In the foregoing content, content of differentially determining the second gate unit corresponding to the first gate unit according to the difference of the connectivity represented by the first information is described. When the first information indicates that the first virtual qubit and the second virtual qubit have the connectivity, additional processing by the physical quantum chip may be avoided, and the first gate unit is determined as the second gate unit. When the first information indicates that the first virtual qubit and the second virtual qubit have no connectivity, to avoid additional logical processing by the physical quantum chip, state swapping needs to be performed between a state of at least one virtual qubit and a state of another virtual qubit in the state swapping link determined according to the topology information. In this way, direct logical processing is avoided, and accuracy of logical processing is improved.

Because a swap gate unit is required during the state swapping, a process of newly adding a gate unit affects the execution result of the quantum task. In one embodiment, the computer device controls a quantity of virtual qubits included in the state swapping link in the process of determining the state swapping link, to reduce a quantity of required swap gate units. For example, when a plurality of state swapping links exist between the first virtual qubit and the second virtual qubit, the computer device selects a state swapping link including a smallest quantity of virtual qubits from the plurality of state swapping links, and performs division on the state swapping link to obtain the first state swapping link and the second state swapping link. Through the method, a quantity of required swap gate units can be reduced, and impact of the method on the execution result of the quantum task can be reduced.

In some implementations, that the computer device determines at least one swap gate unit according to the state swapping link includes: establishing a swap gate unit between two adjacent virtual qubits in the state swapping link, the swap gate unit being configured for implementing state swapping between the two virtual qubits having connectivity.

In some embodiments, the state swapping link includes at least one of the following: a first state swapping link or a second state swapping link, the first state swapping link including at least one virtual qubit including the first virtual qubit, the second state swapping link including at least one virtual qubit including the second virtual qubit, and a last virtual qubit in the first state swapping link and a last virtual qubit in the second state swapping link having connectivity. That the computer device determines at least one swap gate unit according to the state swapping link includes: for any one of the first state swapping link and the second state swapping link, when the state swapping link includes at least two virtual qubits, determining, for any two adjacent virtual qubits in the state swapping link, one swap gate unit between the adjacent virtual qubits.

When the state swapping link includes one virtual qubit, the virtual qubit is a target virtual qubit. In this case, the target virtual qubit is both a first virtual qubit and a last virtual qubit, and a swap gate unit does not need to be established for the virtual qubit in the state swapping link.

In some embodiments, a swap gate unit is referred to as a SWAP gate, to swap states between virtual qubits. When the state swapping link includes a plurality of adjacent virtual qubits, swap gate units respectively corresponding to the plurality of adjacent virtual qubits have execution timing. For example, in the state swapping link, the closer a virtual qubit is to a target virtual qubit, the earlier execution timing of a swap gate unit corresponding to the virtual bit is; and the further away a virtual qubit is from the target virtual qubit, and the later execution timing of a swap gate unit corresponding to the virtual bit is. For example, if a state swapping link is [second virtual qubit, virtual qubit a, virtual qubit b], the computer device determines a swap gate unit 1 between the second virtual qubit and the virtual qubit a, and determines a swap gate unit b between the virtual qubit a and the virtual qubit b, where execution timing of the swap gate unit a takes precedence over execution timing of the swap gate unit b. Through the method, it is ensured that a state of the target virtual qubit can be swapped to a last virtual qubit in the state swapping link, so that subsequent logical processing the same as the first gate unit is performed on the last virtual qubit in the link, and the same function as the first gate unit can be generated.

For example, for swap gate units respectively corresponding to virtual qubits in different state swapping links, execution timing of the swap gate units is not limited. For example, execution timing of a swap gate unit 3 between the virtual qubit 1 and the virtual qubit 2 in the first state swapping link and execution timing of a swap gate unit 4 between the virtual qubit 3 and the virtual qubit 4 in the second state swapping link are not limited. The swap gate unit 3 may perform execution earlier than the swap gate unit 4 in timing, or the swap gate unit 3 may perform execution later than the swap gate unit 4 in timing, or the swap gate unit 3 and the swap gate unit 4 may perform execution in parallel.

In some implementations, the equivalent gate unit includes at least one swap gate unit and a first gate unit. A function of the swap gate unit is described above. The first gate unit is configured to perform logical processing on a last virtual qubit in the first state swapping link and a last virtual qubit in the second state swapping link.

In the foregoing process, content of determining the swap gate unit according to the state swapping link is described. According to the virtual qubits included in the state swapping link, one swap gate unit is determined between any two adjacent virtual qubits. In addition, two state swapping links are described. In the two state swapping circuits, swap gate units may be determined according to adjacent virtual qubits. Because the state of the first virtual qubit can be swapped to the last virtual qubit in the first state swapping link, and the state of the second virtual qubit can be swapped to the last virtual qubit in the second state swapping link, the second gate unit is arranged between the last virtual qubit in the first state swapping link and the last virtual qubit in the second state swapping link. In this way, the same effect as that the first gate unit processes the first logical qubit and the second logical qubit in the logical quantum circuit can be achieved. Through the method, a logical operation equivalent to that of the first gate unit is implemented between virtual qubits having no connectivity, so that the quantum task can be smoothly executed.

Because newly adding a quantum gate (such as the swap gate designed above) to the original logical quantum circuit may affect a running process of the physical quantum chip, the execution result of the quantum task is affected. For different quantum tasks, in the process of generating the virtual quantum circuit, the impact of whether to newly add quantum gates on execution results is not exactly the same. In the solution, whether to newly add a quantum gate in the process of generating the virtual quantum circuit is determined by using equivalence indication information.

In some embodiments, before the determining a state swapping link according to the topology information of the virtual quantum chip, the method further includes: obtaining equivalence indication information, the equivalence indication information being configured for representing an allowing situation for at least one different gate unit between the logical quantum circuit and the virtual quantum circuit; and determining the state swapping link according to the topology information of the virtual quantum chip when the equivalence indication information represents that the at least one different gate unit is allowed to exist between the logical quantum circuit and the virtual quantum circuit; or returning an error prompt when the equivalence indication information represents that the at least one different gate unit is not allowed to exist between the logical quantum circuit and the virtual quantum circuit, the error prompt being configured for representing that the execution of the quantum task fails.

The allowing situation is configured for indicating that there is a permission state for a different gate unit. In other words, the equivalence indication information is configured for representing whether the at least one different gate unit is allowed to exist between the logical quantum circuit and the virtual quantum circuit. The equivalence indication information includes: The at least one different gate unit is allowed to exist between the logical quantum circuit and the virtual quantum circuit; or the at least one different gate unit is not allowed to exist between the logical quantum circuit and the virtual quantum circuit.

For example, when the equivalence indication information represents that the at least one different gate unit is not allowed to exist between the logical quantum circuit and the virtual quantum circuit, the error prompt is returned, and the operation of determining a state swapping link according to the topology information of the virtual quantum chip is also not performed.

In some embodiments, the equivalence indication information is configured for representing whether a new gate unit can be added to the virtual quantum circuit in the process of generating the virtual quantum circuit. In one embodiment, the equivalence indication information and the task indication information are simultaneously sent to the computer device. Alternatively, when the computer device determines that a gate unit different from that of the logical quantum circuit needs to appear in the virtual quantum circuit, the computer device sends equivalence query information to the terminal device, where the equivalence query information is configured for querying whether the at least one different gate unit is allowed to exist between the logical quantum circuit and the virtual quantum circuit, and the computer device receives the equivalence indication information sent by the terminal device.

In one embodiment, in the process in which the computer device generates the virtual quantum circuit according to the logical quantum circuit, the computer device obtains the equivalence indication information if the first information represents that the first virtual qubit and the second virtual qubit have no connectivity. When the equivalence indication information is that the at least one different gate unit is allowed to exist between the logical quantum circuit and the virtual quantum circuit, execution is performed starting from the operation of the computer device determining a state swapping link according to the topology information of the virtual quantum chip. In other words, the computer device can generate the virtual quantum circuit according to the logical quantum circuit.

When the equivalence indication information is that the at least one different gate unit is not allowed to exist between the logical quantum circuit and the virtual quantum circuit, the computer device does not perform the operation of determining a state swapping link according to the topology information of the virtual quantum chip, and returns the error prompt for representing that the execution of the quantum task fails. In one embodiment, the error prompt is configured for prompting that the execution of the quantum task fails and the execution result of the quantum task cannot be obtained.

In the foregoing process, content of differentially determining the state swapping link according to that the equivalence indication information represents whether the at least one different gate unit is allowed to exist is described. When the equivalence indication information indicates that the at least one different gate unit is allowed to exist between the logical quantum circuit and the virtual quantum circuit, the state swapping link may be determined, to determine the second gate unit. When the equivalence indication information indicates that the at least one different gate unit is not allowed to exist between the logical quantum circuit and the virtual quantum circuit, it may be prompted by feeding back the error prompt that the execution result cannot be obtained, to determine, according to a user need, whether a new gate unit can be added to the virtual quantum circuit. In this way, through interference of the equivalence indication information, unacceptable impact on the execution result of the quantum task due to addition of the gate unit can be avoided; and through differential processing, reliability of the execution result of the quantum task can be improved.

### Example 2: The Method for Generating the Second Gate Unit Corresponding to the First Gate Unit when the First Gate Unit is a Single-Bit Gate

In some embodiments, the determining, according to the topology information of the virtual quantum chip, second gate units respectively corresponding to first gate units in the logical quantum circuit in sub-operation 322 includes: determining, by the computer device for any one of the first gate units, the first gate unit corresponding to one logical qubit as the second gate unit when the first gate unit is configured to perform logical processing on the logical qubit.

The determining the first gate unit corresponding to one logical qubit as the second gate unit is performing logical processing on a virtual qubit corresponding to the logical qubit by using a quantum gate of the same type as the first gate unit. For related content of the operation, refer to the foregoing embodiments. Details are not described herein again.

In the foregoing process, content of determining the second gate unit when the first gate unit is configured to perform logical processing on one logical qubit is described. When the first gate unit is configured to perform logical processing on one logical qubit, other logical qubits are not additionally considered, and the first gate unit corresponding to the logical qubit is determined as the second gate unit. In this way, the second gate unit can perform targeted processing on the virtual qubit corresponding to the logical qubit, so that efficiency of determining the second gate unit can be improved when accuracy of logical processing is not affected.

In an example of generating the virtual quantum circuit, the computer device determines, according to the topology information of the virtual quantum chip, the second gate units respectively corresponding to the first gate units in the logical quantum circuit. In the process, the generation method in which the computer device determines the second gate unit corresponding to the first gate unit according to the type of the first gate unit mainly includes several cases.
Case 1.0 When the first gate unit is configured to perform logical processing on one logical qubit, the first gate unit corresponding to the logical qubit is determined as the second gate unit.
Case 2.0 When the first gate unit is configured to perform logical processing on a first logical qubit and a second logical qubit, the computer device determines, according to the topology information of the virtual quantum chip, first information configured for representing whether a first virtual qubit and a second virtual qubit have connectivity; and determines the first gate unit as the second gate unit if the first information represents that the first virtual qubit and the second virtual qubit have the connectivity.
Case 3.1 When the first gate unit is configured to perform logical processing on a first logical qubit and a second logical qubit, the computer device determines, according to the topology information of the virtual quantum chip, first information configured for representing whether a first virtual qubit and a second virtual qubit have connectivity; the computer device obtains equivalence indication information when the first information represents that the first virtual qubit and the second virtual qubit have no connectivity; and when the equivalence indication information is that at least one different gate unit is allowed to exist between the logical quantum circuit and the virtual quantum circuit, the computer device determines an equivalent gate unit of the first unit, and uses the equivalent gate unit as the second gate unit. For related content of the operation, refer to the foregoing embodiments. Details are not described herein again.
Case 3.2 When the first gate unit is configured to perform logical processing on a first logical qubit and a second logical qubit, the computer device determines, according to the topology information of the virtual quantum chip, first information configured for representing whether a first virtual qubit and a second virtual qubit have connectivity; the computer device obtains equivalence indication information when the first information represents that the first virtual qubit and the second virtual qubit have no connectivity; and when the equivalence indication information is that at least one different gate unit is not allowed to exist between the logical quantum circuit and the virtual quantum circuit, the computer device does not generate an equivalent gate unit of the first gate unit, the quantum task cannot be executed, and the computer device returns an error prompt, that is, it is prompted that the execution of the quantum task fails.

For Case 1.0, Case 2.0, and Case 3.1, the computer device generates the virtual quantum circuit of the quantum task according to the second gate units respectively corresponding to the first gate units and the timing relationship of the first gate units in the logical quantum circuit. The following describes a method for generating the physical quantum circuit through one embodiment. An execution entity of the operation is the server.

In some embodiments, the generating a physical quantum circuit of the quantum task according to the virtual quantum circuit and a bit mapping relationship between the virtual quantum chip and the physical quantum chip in operation 330 may include the following several sub-operations.

Sub-operation 332: Determine, according to the bit mapping relationship, physical qubits respectively corresponding to at least one virtual qubit included in the virtual quantum chip.

For related content of the bit mapping relationship, refer to the foregoing embodiments. Details are not described herein again. In one embodiment, the bit mapping relationship is a mapping relationship between identification information of a virtual qubit and identification information of a physical qubit.

For example, for any one of the virtual qubits included in the virtual quantum circuit, the computer device determines a physical qubit corresponding to the virtual qubit according to the bit mapping relationship and identification information of the virtual qubit.

Sub-operation 334: Replace each virtual qubit in the virtual quantum circuit with the physical qubit corresponding to the virtual qubit, to obtain the physical quantum circuit of the quantum task.

Because the virtual quantum chip and the partial structure corresponding to the virtual quantum chip in the physical quantum chip have the same topology information, a logical operation performed on a virtual qubit can be performed on a physical qubit corresponding to the virtual qubit. In other words, gate units included in the virtual quantum circuit and the physical quantum circuit are the same, and the computer device only needs to replace each virtual qubit in the virtual quantum circuit with the corresponding physical qubit, to obtain the physical quantum circuit of the quantum task.

In the foregoing sub-operation 332 and sub-operation 334, content of obtaining the physical quantum circuit according to the bit mapping relationship is described. A correspondence between virtual qubits and physical qubits is represented based on the bit mapping relationship. Therefore, after the virtual quantum circuit and the virtual qubits in the virtual quantum circuit are determined, the physical qubits respectively corresponding to the plurality of virtual qubits may be determined according to the bit mapping relationship, so that a plurality of physical qubits are determined from the physical quantum chip, and the physical quantum circuit represented by the plurality of physical qubits is generated by replacing the virtual qubits. Through the method, after the physical quantum chip is segmented into the plurality of virtual quantum chips, according to the known bit mapping relationship, the partial structure corresponding to the virtual quantum chip may be more quickly located from the physical quantum chip, and the physical quantum circuit corresponding to the partial structure may be generated. In this way, excessive execution operations are not introduced in the process of generating the execution result of the quantum task, and physical quantum circuits corresponding to different partial structures can also be generated in a more targeted manner, so that operating pressure of the computer device can be reduced when utilization of quantum computing resources is improved, and different quantum tasks can be executed in parallel through different partial structures in the physical quantum chip.

The following describes a process A of generating the physical quantum circuit through one example.

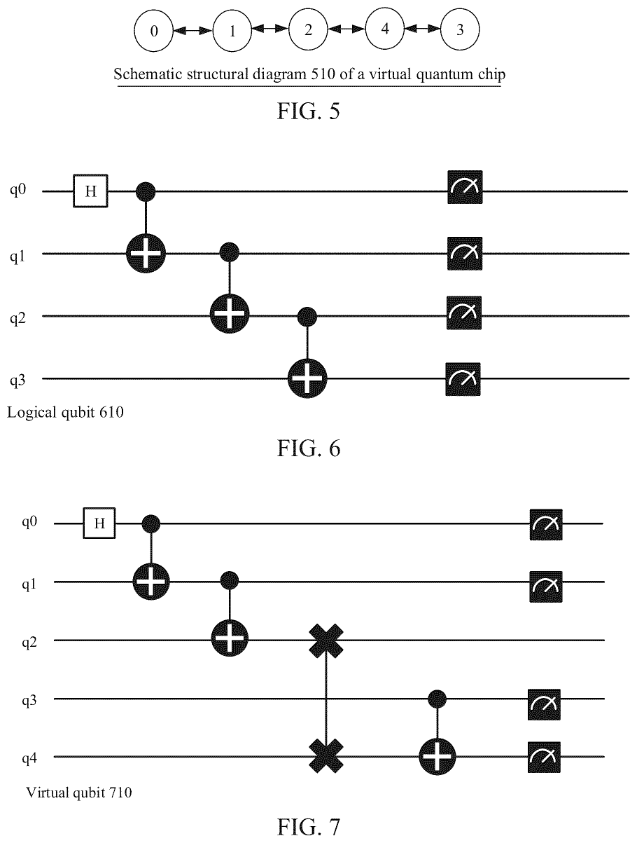

FIG. 5 is a schematic structural diagram 510 of a virtual quantum chip according to an exemplary embodiment of this application. In this example, the virtual quantum chip is used to process a to-be-processed quantum task. The virtual quantum chip includes five virtual qubits: q[0], q[1], q[2], q[3], and q[4], where q[0] and q[1] have connectivity, q[1] and q[2] have connectivity, q[2] and q[4] have connectivity, and q[3] and q[4] have connectivity.

Operation A10: The computer device obtains a logical quantum circuit of a target quantum task. In one embodiment, operation A10 may include the following sub-operations:
obtaining task indication information, the task indication information being configured for indicating the target quantum task; determining, for any one of operation indications included in the task indication information, a first gate unit corresponding to the operation indication and at least one logical qubit on which the first gate unit is configured to perform logical processing; and performing, according to timing information of the operation indications included in the task indication information, timing association on the first gate units respectively corresponding to the operation indications, to generate the logical quantum circuit of the quantum task.

In this example, the task indication information is a quantum program formed by program instructions, which is implemented as follows:
QREG q[4];
H q[0];
CX q[0], q[1];
CX q[1], q[2];
CX q[2], q[3];
MEASZ q[0];
MEASZ q[1];
MEASZ q[3]; and
MEASZ q[4].

QREG q[4] indicates that four logical qubits are required for the target quantum task, and q[0], q[1], q[2], and q[4] indicate the four logical qubits; “H” indicates an H gate, and “H q[0]” indicates logical processing performed by the H gate on the logical qubit q[0]; “CX” indicates a CNOT gate, and “CX q[i], q[j]” indicates logical processing performed by the CNOT gate on q[i] and q[j], where i=0 and j=1, or i=1 and j=2, or i=2 and j=3; and “MEASZ” indicates observation for two qubits. In one embodiment, orders of the program instructions in the quantum program identify timing information of gate units in the logical quantum circuit. For example, in the foregoing quantum program, execution timing of H q[0] takes precedence over execution timing of CX q[0], q[1]; and execution timing of CX q[0], q[1] takes precedence over execution timing of CX q[1], q[2]. Because “MEASZ” does not involve performing a logical operation on a qubit and indicates to observe a state of a logical qubit, execution timing of “MEASZ” is not limited.

FIG. 6 is a schematic diagram of a logical quantum circuit according to an exemplary embodiment of this application. The logical quantum circuit includes a plurality of logical qubits 610: q[0], q[1], q[2], and q[3], and logic gates acting on the logical qubits.
Operation A20: The computer device generates a virtual quantum circuit of the quantum task according to topology information represented by a virtual quantum chip and the logical quantum circuit.

In the operation, the computer device needs to determine, according to the topology information of the virtual quantum chip, second gate units respectively corresponding to first gate units in the logical quantum circuit; and the computer device generates the virtual quantum circuit of the quantum task according to the second gate units respectively corresponding to the first gate units and a timing relationship of the first gate units in the logical quantum circuit.

FIG. 7 is a schematic diagram of a virtual quantum circuit according to an exemplary embodiment of this application. The virtual quantum circuit includes a plurality of virtual qubits 710: q[0], q[1], q[2], q[3], and q[4], and logic gates acting on the logical qubits.

It can be learned from the foregoing embodiment that, in a process of generating the virtual quantum circuit, the second gate units corresponding to the first gate units in the logical quantum circuit need to be determined according to the topology information of the virtual quantum chip.

For an H gate on the logical qubit q[0] in the logical quantum circuit, because the H gate is a single-bit gate, the computer device determines that the H gate is arranged on a line of the virtual qubit q[0].

For a CNOT gate between the logical qubits q[0] and q[1] in the logical quantum circuit, because the virtual qubits q[0] and q[1] have connectivity in the virtual quantum chip, the CNOT gate may be arranged between the virtual qubits q[0] and q[1]. In other words, when the CNOT gate between the logical qubits q[0] and q[1] in the logical quantum circuit is used as a first gate unit, the computer device determines the first gate unit as a second gate unit. Similarly, for a CNOT gate between the logical qubits q[1] and q[2] in the logical quantum circuit, the CNOT gate may be arranged between the virtual qubits q[1] and q[2] in the virtual quantum circuit.

For a CNOT gate between the logical qubits q[2] and q[3] in the logical quantum circuit, in the virtual quantum chip, the virtual qubits q[2] and q[3] have connectivity, the virtual qubits q[2] and q[4] have connectivity, and the virtual qubits q[4] and q[3] have connectivity. Therefore, the computer device arranges a swap gate unit between the virtual qubits q[2] and q[4], and after a state of the virtual qubit q[2] is swapped to the virtual qubit q[4], the computer device arranges a CNOT gate between the virtual qubits q[3] and q[4].

In other words, when the CNOT gate between the logical qubits q[2] and q[3] in the logical quantum circuit is used as a first gate unit, the computer device combines a swap gate between the virtual qubits q[2] and q[4] and the CNOT gate unit between the virtual qubits q[3] and q[4], to obtain a second gate unit corresponding to the first gate unit.

FIG. 8 is a schematic diagram of a correspondence between a virtual quantum chip and a physical quantum chip according to an exemplary embodiment of this application.

As shown in FIG. 8, the virtual quantum chip in FIG. 5 corresponds to a partial structure 810 in the physical quantum chip in FIG. 8, where a virtual qubit q[0] corresponds to a physical qubit q[10], a virtual qubit q[1] corresponds to a physical qubit q[11], a virtual qubit q[2] corresponds to a physical qubit q[12], a virtual qubit q[4] corresponds to a physical qubit q[13], and a virtual qubit q[3] corresponds to a physical qubit q[14].
Operation A30: After generating the virtual quantum circuit, the computer device generates a physical quantum circuit according to the virtual quantum circuit and a bit mapping relationship.

In the operation, the computer device determines, according to the bit mapping relationship, physical qubits respectively corresponding to at least one virtual qubit included in the virtual quantum chip; and the computer device replaces each virtual qubit in the virtual quantum circuit with the physical qubit corresponding to the virtual qubit, to obtain the physical quantum circuit of the quantum task.

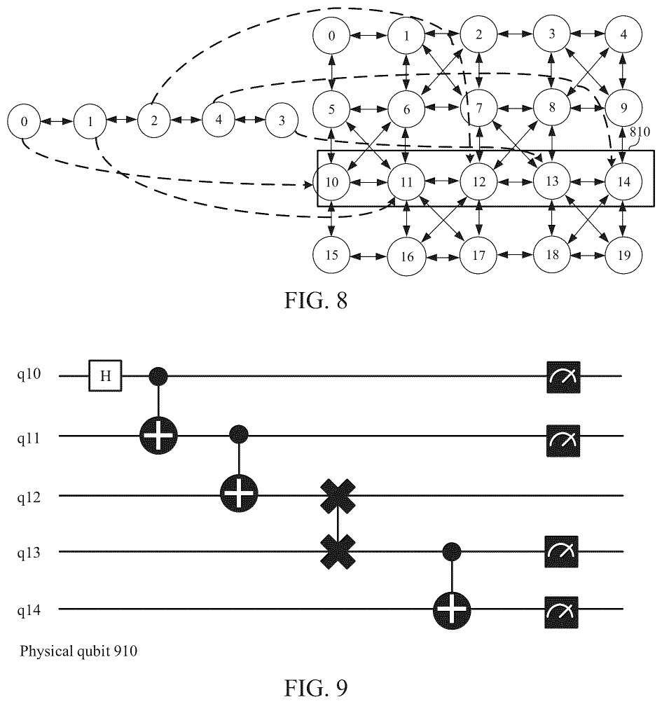

FIG. 9 is a schematic diagram of a physical quantum chip according to an exemplary embodiment of this application. The physical quantum chip includes chrome-plated physical qubits 910: q[10], q[11], q[12], q[13], and q[14].

In comparison with FIG. 9 and FIG. 8, it is not difficult to find that the physical quantum circuit can be obtained by only replacing the virtual qubits in the virtual quantum circuit with the corresponding physical qubits.

After generating the physical quantum circuit, the computer device generates a corresponding instruction set according to the physical quantum circuit, and sends the instruction set to the physical quantum chip. The physical quantum chip performs execution according to the instruction set, to obtain an execution result of the to-be-executed task.

In an exemplary embodiment, a physical quantum circuit corresponding to a first quantum task is executed through a first partial structure in the physical quantum chip, to obtain a first execution result corresponding to the first quantum task; and a physical quantum circuit corresponding to a second quantum task is executed through a second partial structure of the physical quantum chip, to obtain a second execution result corresponding to the second quantum task,
the first quantum task and the second quantum task being synchronously executed different tasks, and the first partial structure and the second partial structure having a relative independency relationship in the physical quantum chip.

For example, the relative independency relationship is configured for indicating that there is no overlapping physical qubit between the first partial structure and the second partial structure. For example, the first partial structure includes a physical qubit 1 and a physical qubit 2, and the second partial structure includes a physical qubit 3 and a physical qubit 4. A physical quantum circuit corresponding to a first quantum task A is executed through the first partial structure, and a physical quantum circuit corresponding to a second quantum task B is executed through the second partial structure.

In the foregoing process, content that a plurality of quantum tasks can be executed through the physical quantum chip is described. Physical quantum circuits respectively corresponding to different quantum tasks are executed through different partial structures in the physical quantum chip. In one embodiment, the process may be implemented in a sequential execution state or in a parallel execution state (synchronous execution state). When implemented in a parallel execution state, corresponding quantum tasks are respectively executed through different partial structures in the physical quantum chip, to improve an execution speed of the quantum tasks, and avoid tedious property of executing different quantum tasks through different physical quantum chips; and a logic execution process is integrated on one physical quantum chip, to facilitate maintenance of the physical quantum chip, and also facilitate differential adjustment of different partial structures, thereby improving logical processing efficiency.

For related content in this embodiment, refer to the foregoing embodiments. This is not described in this application.

In conclusion, through the foregoing method, one physical quantum chip is segmented into a plurality of virtual quantum chips, so that the virtual quantum chips can execute different quantum tasks within the same period, and utilization of quantum computing resources and a response speed of a quantum service platform to a user request are improved without increasing a physical quantum chip.

The following describes a method for segmenting the physical quantum chip through several embodiments.

In some embodiments, the quantum task execution method further includes: obtaining, by the computer device, request information configured for establishing the virtual quantum chip; determining, according to the request information, the bit mapping relationship and requirement topology information of the virtual quantum chip, the requirement topology information being configured for representing the topology relationship required to be met between the virtual qubits included in the virtual quantum chip; and determining, by the computer device, the partial structure corresponding to the virtual quantum chip in the physical quantum chip according to the bit mapping relationship and the requirement topology information of the virtual quantum chip.

In some embodiments, the request information is configured for requesting to segment the physical quantum chip and establish a mapping relationship between the virtual quantum chip and the physical quantum chip. In one embodiment, the request information is provided by an operator maintaining the physical quantum chip, or provided by a user using a quantum computing server.

For example, the request information includes at least one of the following: a chip identifier of the physical quantum chip, a chip identifier of the virtual quantum chip, second information configured for representing the requirement topology information, or third information configured for representing the bit mapping relationship of the virtual quantum chip. The chip identifier of the physical quantum chip is configured for uniquely identifying the physical quantum chip, different physical quantum chips have different chip identifiers, the chip identifier of the virtual quantum chip is configured for uniquely identifying the virtual quantum chip, and different virtual quantum chips have different chip identifiers. The second information is a program segment configured for indicating the requirement topology information, and the third information is a program segment configured for indicating the bit mapping relationship.

In one embodiment, the determining, by the computer device according to the request information, the bit mapping relationship and requirement topology information of the virtual quantum chip includes: performing format processing on the second information, to obtain the requirement topology information of the virtual quantum chip; and performing format processing on the third information, to obtain the bit mapping relationship of the virtual quantum chip.

In the foregoing process, content of determining the partial structure corresponding to the virtual quantum chip in the physical quantum chip according to the request information is described. After obtaining the request information, the physical quantum chip is segmented, and the mapping relationship between the virtual quantum chip and the physical quantum chip is established, to determine the bit mapping relationship and requirement topology information of the virtual quantum chip according to the request information, to determine the partial structure corresponding to the virtual quantum chip from a plurality of partial structures corresponding to the segmented physical quantum chip. The physical quantum chip is segmented according to the request information, so that flexibility of the process of segmenting the physical quantum chip can be improved, and a virtual quantum chip having corresponding topology information can be generated according to an actual need.

In some embodiments, the determining the partial structure corresponding to the virtual quantum chip in the physical quantum chip according to the bit mapping relationship and the requirement topology information of the virtual quantum chip includes: determining, by the computer device from the physical quantum chip according to the bit mapping relationship of the virtual quantum chip, to-be-mapped physical qubits respectively corresponding to the virtual qubits included in the virtual quantum chip; determining, by the computer device when the to-be-mapped physical qubits are all in an unoccupied state, a topology relationship between the to-be-mapped physical qubits according to a physical topology of the physical quantum chip; and determining, by the computer device if the topology relationship between the to-be-mapped physical qubits meets the requirement topology information, a partial structure including the to-be-mapped physical qubits in the physical quantum chip as the partial structure corresponding to the virtual quantum chip in the physical quantum chip.

In one embodiment, after this, the computer device adjusts the physical qubits included in the corresponding partial structure in the physical quantum chip to be in an occupied state.

In some embodiments, the computer device determines whether the topology relationship between the to-be-mapped physical qubits meets the requirement topology information; and the computer device determines, if the topology relationship between the to-be-mapped physical qubits meets the requirement topology information, the partial structure including the to-be-mapped physical qubits in the physical quantum chip as the partial structure corresponding to the virtual quantum chip in the physical quantum chip; or if the topology relationship between the to-be-mapped physical qubits does not meet the requirement topology information, the computer device cannot map the partial structure in the physical quantum chip to the virtual quantum chip.

In the foregoing process, content of determining the corresponding partial structure from the physical quantum chip is described. The physical qubits respectively corresponding to the plurality of virtual qubits in the virtual quantum chip are determined from the physical quantum chip according to the bit mapping relationship, to avoid participation of current physical qubits in a process of executing other quantum tasks and interference with the other quantum tasks when the physical qubits are in the occupied state. In addition, when the plurality of physical qubits are in the unoccupied state, whether the topology relationship between the plurality of physical qubits meets the requirement topology information corresponding to the request information is determined, to determine, when the requirement topology information is met, the part including the plurality of physical qubits as the partial structure required to be determined, thereby improving accuracy of determining the partial structure based on the request information.

The following describes a method for mapping the virtual quantum chip through two examples.

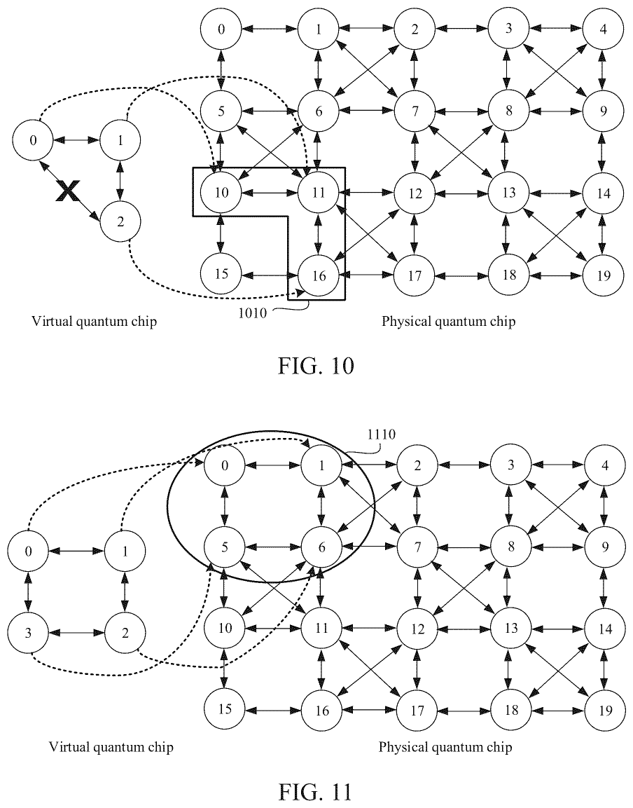

FIG. 10 is a schematic diagram of a process of mapping a virtual quantum chip according to an exemplary embodiment of this application.

As shown in FIG. 10, the virtual quantum chip includes virtual qubits q[0], q[1], and q[2]. Requirement topology information of the virtual quantum chip is that the virtual qubits q[0] and q[1] have connectivity, the virtual qubits q[1] and q[2] have connectivity, and the virtual qubits q[0] and q[2] have connectivity. A bit mapping relationship includes: The virtual qubit q[0] corresponds to a physical qubit q[10], the virtual qubit q[1] corresponds to a physical qubit q[11], and the virtual qubit q[2] corresponds to a physical qubit q[16].

Referring to a physical topology of a physical quantum chip on the right side of FIG. 10, to-be-mapped physical qubits are in a partial structure 1010, where the physical qubits q[10] and q[11] have connectivity, the physical qubits q[11] and q[16] have connectivity, and the physical qubits q[10] and q[16] have no connectivity. Therefore, the computer device determines that a topology relationship between the to-be-mapped physical qubits does not meet the requirement topology information. Therefore, the virtual quantum chip cannot be obtained by segmenting the physical quantum chip.

FIG. 11 is a schematic diagram of a process of mapping a virtual quantum chip according to another exemplary embodiment of this application.

As shown in FIG. 11, the virtual quantum chip includes virtual qubits q[0], q[1], q[2], and q[3]. Requirement topology information of the virtual quantum chip is that the virtual qubits q[0] and q[1] have connectivity, the virtual qubits q[1] and q[2] have connectivity, the virtual qubits q[2] and q[3] have connectivity, and the virtual qubits q[0] and q[3] have connectivity. A bit mapping relationship includes: The virtual qubit q[0] corresponds to a physical qubit q[0], the virtual qubit q[1] corresponds to a physical qubit q[1], the virtual qubit q[3] corresponds to a physical qubit q[5], and the virtual qubit q[2] corresponds to a physical qubit q[6].

Referring to a physical topology of a physical quantum chip on the right side of FIG. 11, to-be-mapped physical qubits are in a partial structure 1110, where the physical qubits q[0] and q[1] have connectivity, the physical qubits q[0] and q[5] have connectivity, the physical qubits q[1] and q[6] have connectivity, and the physical qubits q[6] and q[5] have connectivity. Therefore, the computer device determines that a topology relationship between the to-be-mapped physical qubits meets the requirement topology information, and the virtual quantum chip can be obtained by segmenting the physical quantum chip.

The following describes a process B of executing the quantum task provided in this application through one example.
Operation B10: The computer device obtains request information configured for establishing a virtual quantum chip; and determines, according to the request information, a bit mapping relationship and requirement topology information of the virtual quantum chip.
Operation B20: Determine, according to the bit mapping relationship of the virtual quantum chip, to-be-mapped physical qubits that respectively correspond to virtual qubits included in the virtual quantum chip and that are in a physical quantum chip; determine, when the to-be-mapped physical qubits are all in an unoccupied state, a topology relationship between the to-be-mapped physical qubits according to a physical topology of the physical quantum chip; and determine, if the topology relationship between the to-be-mapped physical qubits meets the requirement topology information, a partial structure including the to-be-mapped physical qubits in the physical quantum chip as a partial structure corresponding to the virtual quantum chip in the physical quantum chip.

After the physical quantum chip is segmented into a plurality of virtual qubits, the process of executing the quantum task is started.
Operation B30: The computer device obtains task indication information; determines, for any one of operation indications included in the task indication information, a first gate unit corresponding to the operation indication and at least one logical qubit on which the first gate unit is configured to perform logical processing; and performs, according to timing information of the operation indications included in the task indication information, timing association on the first gate units respectively corresponding to the operation indications, to generate a logical quantum circuit of the quantum task.
Operation B40: The computer device determines, according to topology information of the virtual quantum chip, second gate units respectively corresponding to the first gate units in the logical quantum circuit. The operation includes a plurality of cases and determining processes. For relevant content, refer to the foregoing embodiment. Details are not described herein again.
Operation B50: The computer device generates a virtual quantum circuit of the quantum task according to the second gate units respectively corresponding to the first gate units and a timing relationship of the first gate units in the logical quantum circuit.
Operation B60: The computer device determines, according to the bit mapping relationship, physical qubits respectively corresponding to at least one virtual qubit included in the virtual quantum chip; and replaces each virtual qubit in the virtual quantum circuit with the physical qubit corresponding to the virtual qubit, to obtain a physical quantum circuit of the quantum task.
Operation B70: The computer device executes the physical quantum circuit through the partial structure in the physical quantum chip, to obtain an execution result of the quantum task. To not add redundant space, for related content of the operations in this embodiment, refer to the embodiments corresponding to the foregoing operations. Details are not described herein again.

Through the method, one physical quantum chip corresponds to a plurality of virtual quantum chips, and the virtual quantum chips limit physical qubits required to execute quantum tasks, to avoid interference between execution processes of two quantum tasks caused when a same physical qubit is involved in the two quantum tasks within the same time period; and a physical topology between the qubits is relieved, so that the physical quantum chip can simultaneously execute a plurality of quantum tasks, thereby improving efficiency of utilization of quantum computing resources, and improving a response speed of the quantum tasks.

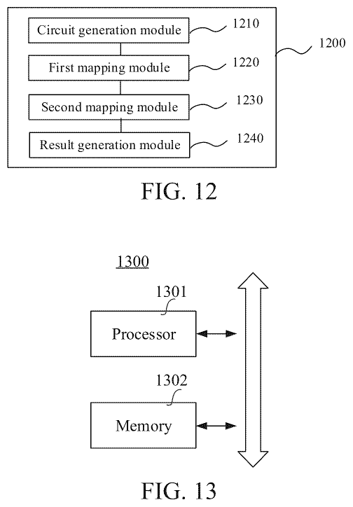

FIG. 12 is a block diagram of a quantum task execution apparatus according to an exemplary embodiment of this application. An apparatus 1200 may include: a circuit generation module 1210, a first mapping module 1220, a second mapping module 1230, and a result generation module 1240.

The circuit generation module 1210 is configured to obtain a logical quantum circuit, the logical quantum circuit being an abstract logic circuit configured to execute a quantum task.

The first mapping module 1220 is configured to generate a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits included in the virtual quantum chip, and the virtual quantum circuit being a circuit constructed based on the virtual qubits.

The second mapping module 1230 is configured to generate a physical quantum circuit of the quantum task according to the virtual quantum circuit and a bit mapping relationship between the virtual quantum chip and the physical quantum chip, the bit mapping relationship being configured for indicating physical qubits corresponding to the virtual qubits in the physical quantum chip.

The result generation module 1240 is configured to execute the physical quantum circuit through the partial structure in the physical quantum chip, to obtain an execution result of the quantum task.

In some embodiments, the result generation module 1240 is further configured to execute a physical quantum circuit corresponding to a first quantum task through a first partial structure in the physical quantum chip, to obtain a first execution result corresponding to the first quantum task; and execute a physical quantum circuit corresponding to a second quantum task through a second partial structure of the physical quantum chip, to obtain a second execution result corresponding to the second quantum task, the first quantum task and the second quantum task being synchronously executed different tasks, and the first partial structure and the second partial structure having a relative independency relationship in the physical quantum chip.

In some embodiments, the first mapping module 1220 further includes: a gate unit generation sub-module, configured to determine, according to the topology information of the virtual quantum chip, second gate units respectively corresponding to first gate units in the logical quantum circuit, the first gate units being quantum gates configured to perform logical processing on logical qubits in the logical quantum circuit, and the second gate units being quantum gates configured to perform the same logical processing on the virtual qubits as the first gate units; and a circuit generation sub-module, configured to generate the virtual quantum circuit of the quantum task according to the second gate units respectively corresponding to the first gate units and a timing relationship of the first gate units in the logical quantum circuit.

In some embodiments, the gate unit generation sub-module includes: an information determining unit, configured to: for any one of the first gate units, determine, according to the topology information of the virtual quantum chip when the first gate unit is configured to perform logical processing on a first logical qubit and a second logical qubit, first information configured for representing a connection association relationship between a first virtual qubit and a second virtual qubit, the first virtual qubit corresponding to the first logical qubit, and the second virtual qubit corresponding to the second logical qubit; and a gate determining unit, configured to determine the second gate unit corresponding to the first gate unit according to the first information.

In some embodiments, the information determining unit includes: a first sub-unit, configured to determine the first gate unit as the second gate unit if the first information represents that the first virtual qubit and the second virtual qubit have connectivity; and a second sub-unit, configured to determine, if the first information represents that the first virtual qubit and the second virtual qubit have no connectivity, a state swapping link according to the topology information of the virtual quantum chip, the state swapping link being configured for swapping a state of at least one of the first virtual qubit or the second virtual qubit; determine at least one swap gate unit according to the state swapping link; and determine an equivalent gate unit obtained by combining the at least one swap gate unit and the first gate unit as the second gate unit, the swap gate unit being configured to swap states respectively possessed by two qubits inputted into the swap gate unit, and operation timing of the swap gate unit taking precedence over operation timing of the first gate unit in the equivalent gate unit.

In some embodiments, the second sub-unit is configured to: for any one of the first state swapping link and the second state swapping link, when the state swapping link includes at least two virtual qubits, determine, for any two adjacent virtual qubits in the state swapping link, one swap gate unit between the adjacent virtual qubits, the state swapping link including at least one of the following: a first state swapping link or a second state swapping link, the first state swapping link including at least one virtual qubit including the first virtual qubit, the second state swapping link including at least one virtual qubit including the second virtual qubit, and a last virtual qubit in the first state swapping link and a last virtual qubit in the second state swapping link having connectivity.

In some embodiments, the apparatus 1200 further includes: an information determining module, configured to obtain equivalence indication information, the equivalence indication information being configured for representing an allowing situation for at least one different gate unit between the logical quantum circuit and the virtual quantum circuit; and determine the state swapping link according to the topology information of the virtual quantum chip when the equivalence indication information represents that the at least one different gate unit is allowed to exist between the logical quantum circuit and the virtual quantum circuit; or return an error prompt when the equivalence indication information represents that the at least one different gate unit is not allowed to exist between the logical quantum circuit and the virtual quantum circuit, the error prompt being configured for representing that the execution of the quantum task fails.

In some embodiments, the gate unit generation sub-module is configured to determine, for any one of the first gate units, the first gate unit as the second gate unit when the first gate unit is configured to perform logical processing on one logical qubit.

In some embodiments, the circuit generation module 1210 is configured to obtain task indication information, the task indication information being configured for indicating the target quantum task; determine, for any one of operation indications included in the task indication information, a first gate unit corresponding to the operation indication and at least one logical qubit on which the first gate unit is configured to perform logical processing; and perform, according to timing information of the operation indications included in the task indication information, timing association on the first gate units respectively corresponding to the operation indications, to generate the logical quantum circuit of the quantum task.

In some embodiments, the apparatus 1200 further includes: an information obtaining module, configured to obtain request information configured for establishing the virtual quantum chip; an information determining module, configured to determine, according to the request information, the bit mapping relationship and requirement topology information of the virtual quantum chip, the requirement topology information being configured for representing the topology relationship required to be met between the virtual qubits included in the virtual quantum chip; and a chip mapping module, configured to determine the partial structure corresponding to the virtual quantum chip in the physical quantum chip according to the bit mapping relationship and the requirement topology information of the virtual quantum chip.

In some embodiments, the chip mapping module is configured to determine, from the physical quantum chip according to the bit mapping relationship of the virtual quantum chip, to-be-mapped physical qubits respectively corresponding to the virtual qubits included in the virtual quantum chip; determine, when the to-be-mapped physical qubits are all in an unoccupied state, a topology relationship between the to-be-mapped physical qubits according to a physical topology of the physical quantum chip; and determine, if the topology relationship between the to-be-mapped physical qubits meets the requirement topology information, a partial structure including the to-be-mapped physical qubits in the physical quantum chip as the partial structure corresponding to the virtual quantum chip in the physical quantum chip.

In some embodiments, the second mapping module 1230 is configured to determine physical qubits respectively corresponding to at least one virtual qubit included in the virtual quantum chip according to the bit mapping relationship; and replace each virtual qubit in the virtual quantum circuit with the physical qubit corresponding to the virtual qubit, to obtain the physical quantum circuit of the quantum task.

When the apparatus provided in the above embodiments implements functions of the apparatus, the division of the above functional modules is merely an example for description. In the practical application, the functions may be assigned to and completed by different functional modules according to the requirements, that is, the internal structure of the device is divided into different functional modules, to implement all or some of the functions described above. In addition, the apparatuses provided in the foregoing embodiments and the method embodiments fall within a same conception. For details of a specific implementation process, refer to the method embodiments. Details are not described herein again. For beneficial effects of the apparatus in the foregoing embodiments, refer to descriptions of the method embodiments. Details are not described herein again.

FIG. 13 is a structural block diagram of a computer device according to an exemplary embodiment of this application. Generally, a computer device 1300 includes a processor 1301 and a memory 1302.

The processor 1301 may include one or more processing cores. For example, the processor 1301 may be a 4-core processor or a 13-core processor.

The memory 1302 may include one or more computer-readable storage media. The computer-readable storage medium may be tangible and non-transient. The memory 1302 may further include a high-speed random access memory and a non-volatile memory, for example, one or more disk storage devices or flash storage devices. In some embodiments, a non-transitory computer-readable storage medium in the memory 1302 has at least one program stored therein, the at least one program being configured to be executed by the processor 1301 to implement the quantum task execution method provided in the foregoing method embodiments.

An embodiment of this application further provides a non-transitory computer-readable storage medium, having a computer program stored therein, the computer program being loaded and executed by a processor to implement the quantum task execution method provided in the foregoing method embodiments.

The computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data.

An embodiment of this application further provides a computer program product, including a computer program, the computer program being stored in a computer-readable storage medium, and a processor reading the computer program from the computer-readable storage medium and executing the computer program, to implement the quantum task execution method provided in the foregoing method embodiments.

“Plurality of” mentioned in this specification means two or more. The term “and/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

“Plurality of” mentioned in this specification means two or more. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in this embodiment of this application.

The above descriptions are merely exemplary embodiments of this application, but are not intended to limit this application. Any modification, equivalent replacement, or improvement made within the spirit and principle of this application shall fall within the protection scope of this application.

What is claimed is:

1. A quantum task execution method performed by a computer device, the method comprising:
obtaining a logical quantum circuit, the logical quantum circuit being an abstract logic circuit configured to execute a quantum task;
generating a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits comprised in the virtual quantum chip;
generating a physical quantum circuit in the physical quantum chip for the quantum task according to the virtual quantum circuit and a bit mapping relationship between the virtual quantum chip and the physical quantum chip, the bit mapping relationship being configured for indicating physical qubits corresponding to the virtual qubits in the physical quantum chip; and
executing the physical quantum circuit through the partial structure in the physical quantum chip, to obtain an execution result of the quantum task.

2. The method according to claim 1, wherein the executing the physical quantum circuit through the partial structure in the physical quantum chip, to obtain an execution result of the quantum task comprises:
executing a physical quantum circuit corresponding to a first quantum task through a first partial structure in the physical quantum chip, to obtain a first execution result corresponding to the first quantum task; and
executing a physical quantum circuit corresponding to a second quantum task through a second partial structure in the physical quantum chip, to obtain a second execution result corresponding to the second quantum task, the first quantum task and the second quantum task being synchronously executed different tasks, and the first partial structure and the second partial structure having a relative independency relationship in the physical quantum chip.

3. The method according to claim 1, wherein the generating a physical quantum circuit in the physical quantum chip for the quantum task according to topology information represented by a virtual quantum chip and the logical quantum circuit comprises:
determining, according to the topology information of the virtual quantum chip, second gate units respectively corresponding to first gate units in the logical quantum circuit, the first gate units being quantum gates configured to perform logical processing on logical qubits in the logical quantum circuit, and the second gate units being quantum gates configured to perform the same logical processing on the virtual qubits as the first gate units; and
generating the virtual quantum circuit in the physical quantum chip for the quantum task according to the second gate units respectively corresponding to the first gate units and a timing relationship of the first gate units in the logical quantum circuit.

4. The method according to claim 1, wherein the obtaining a logical quantum circuit comprises:
obtaining task indication information, the task indication information being configured for indicating a target quantum task;
determining, for any one of operation indications comprised in the task indication information, a first gate unit corresponding to the operation indication and at least one logical qubit on which the first gate unit is configured to perform logical processing; and
performing, according to timing information of the operation indications comprised in the task indication information, timing association on the first gate units respectively corresponding to the operation indications, to generate the logical quantum circuit of the quantum task.

5. The method according to claim 1, further comprising:
obtaining request information configured for establishing the virtual quantum chip;
determining, according to the request information, the bit mapping relationship and requirement topology information of the virtual quantum chip, the requirement topology information being configured for representing the topology relationship required to be met between the virtual qubits comprised in the virtual quantum chip; and
determining the partial structure corresponding to the virtual quantum chip in the physical quantum chip according to the bit mapping relationship and the requirement topology information of the virtual quantum chip.

6. The method according to claim 5, wherein the determining the partial structure corresponding to the virtual quantum chip in the physical quantum chip according to the bit mapping relationship and the requirement topology information of the virtual quantum chip comprises:
determining, from the physical quantum chip according to the bit mapping relationship of the virtual quantum chip, to-be-mapped physical qubits respectively corresponding to the virtual qubits comprised in the virtual quantum chip;
determining, when the to-be-mapped physical qubits are all in an unoccupied state, a topology relationship between the to-be-mapped physical qubits according to a physical topology of the physical quantum chip; and
determining, if the topology relationship between the to-be-mapped physical qubits meets the requirement topology information, a partial structure comprising the to-be-mapped physical qubits in the physical quantum chip as the partial structure corresponding to the virtual quantum chip in the physical quantum chip.

7. The method according to claim 1, wherein the generating a physical quantum circuit of the quantum task according to the virtual quantum circuit and a bit mapping relationship between the virtual quantum chip and the physical quantum chip comprises:
determining, according to the bit mapping relationship, physical qubits respectively corresponding to at least one virtual qubit comprised in the virtual quantum chip; and
replacing each virtual qubit in the virtual quantum circuit with the physical qubit corresponding to the virtual qubit, to obtain the physical quantum circuit of the quantum task.

8. A computer device, comprising a processor and a memory, the memory having a computer program stored therein that, when loaded and executed by the processor, causes the computer device to implement a quantum task execution method including:
obtaining a logical quantum circuit, the logical quantum circuit being an abstract logic circuit configured to execute a quantum task;
generating a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits comprised in the virtual quantum chip;
generating a physical quantum circuit in the physical quantum chip for the quantum task according to the virtual quantum circuit and a bit mapping relationship between the virtual quantum chip and the physical quantum chip, the bit mapping relationship being configured for indicating physical qubits corresponding to the virtual qubits in the physical quantum chip; and
executing the physical quantum circuit through the partial structure in the physical quantum chip, to obtain an execution result of the quantum task.

9. The computer device according to claim 8, wherein the executing the physical quantum circuit through the partial structure in the physical quantum chip, to obtain an execution result of the quantum task comprises:
executing a physical quantum circuit corresponding to a first quantum task through a first partial structure in the physical quantum chip, to obtain a first execution result corresponding to the first quantum task; and
executing a physical quantum circuit corresponding to a second quantum task through a second partial structure in the physical quantum chip, to obtain a second execution result corresponding to the second quantum task, the first quantum task and the second quantum task being synchronously executed different tasks, and the first partial structure and the second partial structure having a relative independency relationship in the physical quantum chip.

10. The computer device according to claim 8, wherein the generating a physical quantum circuit in the physical quantum chip for the quantum task according to topology information represented by a virtual quantum chip and the logical quantum circuit comprises:
determining, according to the topology information of the virtual quantum chip, second gate units respectively corresponding to first gate units in the logical quantum circuit, the first gate units being quantum gates configured to perform logical processing on logical qubits in the logical quantum circuit, and the second gate units being quantum gates configured to perform the same logical processing on the virtual qubits as the first gate units; and
generating the virtual quantum circuit in the physical quantum chip for the quantum task according to the second gate units respectively corresponding to the first gate units and a timing relationship of the first gate units in the logical quantum circuit.

11. The computer device according to claim 8, wherein the obtaining a logical quantum circuit comprises:
obtaining task indication information, the task indication information being configured for indicating a target quantum task;
determining, for any one of operation indications comprised in the task indication information, a first gate unit corresponding to the operation indication and at least one logical qubit on which the first gate unit is configured to perform logical processing; and
performing, according to timing information of the operation indications comprised in the task indication information, timing association on the first gate units respectively corresponding to the operation indications, to generate the logical quantum circuit of the quantum task.

12. The computer device according to claim 8, wherein the method further comprises:
obtaining request information configured for establishing the virtual quantum chip;
determining, according to the request information, the bit mapping relationship and requirement topology information of the virtual quantum chip, the requirement topology information being configured for representing the topology relationship required to be met between the virtual qubits comprised in the virtual quantum chip; and
determining the partial structure corresponding to the virtual quantum chip in the physical quantum chip according to the bit mapping relationship and the requirement topology information of the virtual quantum chip.

13. The computer device according to claim 12, wherein the determining the partial structure corresponding to the virtual quantum chip in the physical quantum chip according to the bit mapping relationship and the requirement topology information of the virtual quantum chip comprises:
determining, from the physical quantum chip according to the bit mapping relationship of the virtual quantum chip, to-be-mapped physical qubits respectively corresponding to the virtual qubits comprised in the virtual quantum chip;
determining, when the to-be-mapped physical qubits are all in an unoccupied state, a topology relationship between the to-be-mapped physical qubits according to a physical topology of the physical quantum chip; and
determining, if the topology relationship between the to-be-mapped physical qubits meets the requirement topology information, a partial structure comprising the to-be-mapped physical qubits in the physical quantum chip as the partial structure corresponding to the virtual quantum chip in the physical quantum chip.

14. The computer device according to claim 8, wherein the generating a physical quantum circuit of the quantum task according to the virtual quantum circuit and a bit mapping relationship between the virtual quantum chip and the physical quantum chip comprises:
determining, according to the bit mapping relationship, physical qubits respectively corresponding to at least one virtual qubit comprised in the virtual quantum chip; and
replacing each virtual qubit in the virtual quantum circuit with the physical qubit corresponding to the virtual qubit, to obtain the physical quantum circuit of the quantum task.

15. A non-transitory computer-readable storage medium, having a computer program stored therein that, when loaded and executed by a processor of the computer device, causes the computer device to implement a quantum task execution method including:
obtaining a logical quantum circuit, the logical quantum circuit being an abstract logic circuit configured to execute a quantum task;
generating a virtual quantum circuit of the quantum task according to topology information represented by a virtual quantum chip and the logical quantum circuit, the virtual quantum chip corresponding to a partial structure in a physical quantum chip, the topology information being configured for representing a topology relationship between virtual qubits comprised in the virtual quantum chip;
generating a physical quantum circuit in the physical quantum chip for the quantum task according to the virtual quantum circuit and a bit mapping relationship between the virtual quantum chip and the physical quantum chip, the bit mapping relationship being configured for indicating physical qubits corresponding to the virtual qubits in the physical quantum chip; and
executing the physical quantum circuit through the partial structure in the physical quantum chip, to obtain an execution result of the quantum task.

16. The non-transitory computer-readable storage medium according to claim 15, wherein the executing the physical quantum circuit through the partial structure in the physical quantum chip, to obtain an execution result of the quantum task comprises:
executing a physical quantum circuit corresponding to a first quantum task through a first partial structure in the physical quantum chip, to obtain a first execution result corresponding to the first quantum task; and
executing a physical quantum circuit corresponding to a second quantum task through a second partial structure in the physical quantum chip, to obtain a second execution result corresponding to the second quantum task, the first quantum task and the second quantum task being synchronously executed different tasks, and the first partial structure and the second partial structure having a relative independency relationship in the physical quantum chip.

17. The non-transitory computer-readable storage medium according to claim 15, wherein the generating a physical quantum circuit in the physical quantum chip for the quantum task according to topology information represented by a virtual quantum chip and the logical quantum circuit comprises:
determining, according to the topology information of the virtual quantum chip, second gate units respectively corresponding to first gate units in the logical quantum circuit, the first gate units being quantum gates configured to perform logical processing on logical qubits in the logical quantum circuit, and the second gate units being quantum gates configured to perform the same logical processing on the virtual qubits as the first gate units; and
generating the virtual quantum circuit in the physical quantum chip for the quantum task according to the second gate units respectively corresponding to the first gate units and a timing relationship of the first gate units in the logical quantum circuit.

18. The non-transitory computer-readable storage medium according to claim 15, wherein the obtaining a logical quantum circuit comprises:
obtaining task indication information, the task indication information being configured for indicating a target quantum task;
determining, for any one of operation indications comprised in the task indication information, a first gate unit corresponding to the operation indication and at least one logical qubit on which the first gate unit is configured to perform logical processing; and
performing, according to timing information of the operation indications comprised in the task indication information, timing association on the first gate units respectively corresponding to the operation indications, to generate the logical quantum circuit of the quantum task.

19. The non-transitory computer-readable storage medium according to claim 15, wherein the method further comprises:
obtaining request information configured for establishing the virtual quantum chip;
determining, according to the request information, the bit mapping relationship and requirement topology information of the virtual quantum chip, the requirement topology information being configured for representing the topology relationship required to be met between the virtual qubits comprised in the virtual quantum chip; and
determining the partial structure corresponding to the virtual quantum chip in the physical quantum chip according to the bit mapping relationship and the requirement topology information of the virtual quantum chip.

20. The non-transitory computer-readable storage medium according to claim 15, wherein the generating a physical quantum circuit of the quantum task according to the virtual quantum circuit and a bit mapping relationship between the virtual quantum chip and the physical quantum chip comprises:
determining, according to the bit mapping relationship, physical qubits respectively corresponding to at least one virtual qubit comprised in the virtual quantum chip; and
replacing each virtual qubit in the virtual quantum circuit with the physical qubit corresponding to the virtual qubit, to obtain the physical quantum circuit of the quantum task.
